(19) United States
(12) Patent Application Publication
(10) Pub. No.: US 2004/0139407 A1
(43) Pub. Date: Jul. 15, 2004

(54) Semiconductor device layout inspection method

(76) Inventors: Kiyohito Mukai, Souraku-gun (JP); Hidenori Shibata, Shijonawate-shi (JP); Masahiko Kumashiro, Settsu-shi (JP); Hiroyuki Tsujikawa, Kusatsu-shi (JP)

Correspondence Address: STEVENS DAVIS MILLER & MOSHER, LLP, 1615 L STREET, NW, SUITE 850, WASHINGTON, DC, 20036, US

(21) Appl. No.: 10/715,119

(22) Filed: Nov. 18, 2003

(30) Foreign Application Priority Data
Nov. 22, 2002 (JP) 2002-338980

(51) Int. Cl. G06F 17/50

(52) U.S. Cl. 716/4; 716/12

(57) ABSTRACT

An object of the invention is to discover at the chip level a portion of a high density of contact holes in wires of a large area that becomes a portion where wire defects will occur. In order to achieve this, the area ratio of the total area of wires of the same node to the total area of contact holes in the wires of the same node is limited in a chip layout and wire formation defects are detected by determining whether or not defects exists based on this limitation. Thus, defects are detected wherein the area ratio exceeds the limit at the layout design stage and thereby formation defects such as a disconnection of a wire of a large area, a wire breakdown, a surface peeling due to a hillock or a defective connection between a wire and a contact hole can be avoided.

### BACKGROUND OF THE INVENTION

1. Field of the Invention

This invention relates in particular to the semiconductor device layout inspection method for taking measures of the wire formation defects.

2. Description of the Prior Art

Conventionally, the following measurements have been carried out in order to prevent the occurrence of hillocks in wires of a large area covered with an insulating film, which is a thin film and in order to prevent wire defects from occurring at the time of manufacturing the semiconductor device.

The width and the length of a wire is divided into pieces no greater than the critical dimensions so that no hillocks will occur in a semiconductor device having wires of a large area formed on a semiconductor substrate via an insulating film as shown, for example, in Japanese unexamined patent publication H8 (1996)-115914. Then the respective wires that have been divided are electrically connected to each other by means of other wires. The wires for connecting the wires that have been divided are placed in a non-overlapping manner so that no hillocks will occur in the combination with the wires that have been divided.

Wire uplift due to a hillock and a defect of a connection portion of a contact hole and a wire may occur in the step of ashing or of washing in the case wherein the contact holes are provided in a high concentration in wires of a large area according to a conventional manufacture of a semiconductor device. Thereby, a disconnection of a wire, a breakdown of a wire and a surface peeling will occur in a portion of wires of a large area due to the heat at the time of deposition of a CVD film as an upper layer.

### SUMMARY OF THE INVENTION

An object of this invention is to provide a semiconductor device layout inspection method wherein a portion of a high density of contact holes in wires of a large area where wire defects will occur can be detected at the chip level.

The semiconductor device layout inspection method according to the first invention is a method for inspecting formation defects that will occur in wires of a chip layout, wherein the wire formation defects are detected by checking the relationship between the layout of the contact holes in the wires and the layout of the wires.

According to the first invention the wire formation defects are detected by checking the relationship between the layout of the contact holes in the wires and the layout of the wires and, therefore, occurrence of hillocks can be prevented so that wire defects can be prevented from occurring at the time of manufacturing a semiconductor device in the case wherein the density of the contact holes is high in the wires of a large area.

It is preferable in the method according to the first invention for the layout of wires where wire formation defects have been detected to be corrected.

Thus, defects of wire peeling due to hillocks on wires having a wide width can be reduced in the case wherein the layout of wires where wire formation defects have been detected is corrected.

The semiconductor device layout inspection method according to the second invention is a method for inspecting formation defects that will occur in wires of a chip layout, wherein the wire formation defects are detected by providing limitation to the area ratio of the total area of the wires of the same node to the total area of the contact holes in the wires of the same node of the chip layout so that existence of defects is determined based on this limitation.

According to the second invention, the wire formation defects are detected by providing limitation to the area ratio of the total area of the wires of the same node to the total area of the contact holes in the wires of the same node of the chip layout so that existence of defects is determined based on this limitation and, therefore, defects that exceed the area ratio limitation can be detected at the layout designing stage and, thereby, formation defects such as wire disconnections, breakdowns and peelings from the surface of the wires of a large area due to hillocks and failures in connections between the wires and contact holes can be avoided.

The semiconductor device layout inspection method according to the third invention is a method for inspecting formation defects that will occur in wires of a chip layout, wherein the wire formation defects are detected by providing limitation to the number of contact holes in the wires of the same node so that existence of defects is determined based on this number limitation.

According to the third invention, the wire formation defects are detected by providing limitation to the number of contact holes in the wires of the same node so that existence of defects is determined based on this number limitation and, therefore, defects that exceed the number limitation can be detected at the layout designing stage and, thereby, formation defects such as wire disconnections, breakdowns and peelings from the surface of the wires of a large area due to hillocks and failures in connections between the wires and contact holes can be avoided.

The semiconductor device layout inspection method according to the fourth invention is a method for inspecting formation defects that will occur in wires of a chip layout, wherein the wire formation defects are detected by providing limitation to the number of contact holes in the wires having a constant width so that existence of defects is determined based on this number limitation.

According to the fourth invention the wire formation defects are detected by providing limitation to the number of contact holes in the wires having a constant width so that existence of defects is determined based on this number limitation and, therefore, defects that exceed the number limitation can be detected at the layout designing stage and, thereby, formation defects such as wire disconnections, breakdowns and peelings from the surface of the wires of a large area due to hillocks and failures in connections between the wires and contact holes can be avoided.

The semiconductor device layout inspection method according to the fifth invention is a method for inspecting formation defects that will occur in wires of a chip layout, wherein the wire formation defects are detected by providing limitation to the total area of contact holes in the wires having a constant width so that existence of defects is determined based on this area limitation.

According to the fifth invention the wire formation defects are detected by providing limitation to the total area of contact holes in the wires having a constant width so that existence of defects is determined based on this area limitation and, therefore, defects that exceed the area limitation can be detected at the layout designing stage and, thereby, formation defects such as wire disconnections, breakdowns and peelings from the surface of the wires of a large area due to hillocks and failures in connections between the wires and contact holes can be avoided.

The semiconductor device layout inspection method according to the sixth invention is a method for inspecting formation defects that will occur in wires of a chip layout, comprising: the step of calculating the total area of the wires of the same node and the total area of the contact holes in the wires of the same node; and the step of determining the area limitation value of the contact holes in accordance with the total area of the wires of the same node, wherein the area of the same node is detected as a wire formation defect when the total area of the contact holes is equal to, or is greater than, the area limitation value.

According to the sixth invention the step of calculating the total area of the wires of the same node and the total area of the contact holes in the wires of the same node; and the step of determining the area limitation value of the contact holes in accordance with the total area of the wires of the same node are included, wherein the area of the same node is detected as a wire formation defect when the total area of the contact holes is equal to, or is greater than, the area limitation value and, therefore, the limitation of the total area of the contact holes varies in accordance with the total area of the wires of the same node and, thereby, the same working effects as of the second invention can be gained and the limitation value can be microscopically adjusted with a high precision in accordance with the width/area of the wires.

The semiconductor device layout inspection method according to the seventh invention is a method for inspecting formation defects that will occur in wires of a chip layout, comprising: the step of calculating the total area of the wires of the same node and the number of the contact holes in the wires of the same node; and the step of determining the number limitation value of the contact holes in accordance with the total area of the wires of the same node, wherein the area of the same node is detected as a wire formation defect when the number of the contact holes is equal to, or is greater than, the number limitation value.

According to the seventh invention, the step of calculating the total area of the wires of the same node and the number of the contact holes in the wires of the same node; and the step of determining the number limitation value of the contact holes in accordance with the total area of the wires of the same node, are provided wherein the area of the same node is detected as a wire formation defect when the number of the contact holes is equal to, or is greater than, the number limitation value and, therefore, the number limitation of the contact holes varies in accordance with the total area of the wires of the same node and, thereby, the same working effects as of the third invention can be gained and the limitation value can be microscopically adjusted with a high precision in accordance with the width/area of the wires.

The semiconductor device layout inspection method according to the eighth invention is a method for inspecting formation defects that will occur in wires of a chip layout, comprising: the step of calculating the number of the contact holes in the wires having a constant width; and the step of determining the number limitation value of the contact holes that varies in accordance with the wire width, wherein the area concerning the contact holes is detected as a wire formation defect when the number of the contact holes is equal to, or is greater than, the number limitation value.

According to the eighth invention, the step of calculating the number of the contact holes in the wires having a constant width; and the step of determining the number limitation value of the contact holes that varies in accordance with the wire width, are provided wherein the area concerning the contact holes is detected as a wire formation defect when the number of the contact holes is equal to, or is greater than, the number limitation value and, therefore, the number limitation of the contact holes varies in accordance with the width of the wires and, thereby, the same working effects as of the fourth invention can be gained and the limitation value can be microscopically adjusted with a high precision in accordance with the width/area of the wires.

The semiconductor device layout inspection method according to the ninth invention for inspecting formation defects that will occur in wires of a chip layout, comprising: the step of calculating the total area of the contact holes in the wires having a constant width; and the step of determining the area limitation value of the contact holes that varies in accordance with the wire width, wherein the area concerning the contact holes is detected as a wire formation defect when the total area of the contact holes is equal to, or is greater than, the area limitation value.

According to the ninth invention, the step of calculating the total area of the contact holes in the wires having a constant width; and the step of determining the area limitation value of the contact holes that varies in accordance with the wire width are provided, wherein the area concerning the contact holes is detected as a wire formation defect when the total area of the contact holes is equal to, or is greater than, the area limitation value and, therefore, the area limitation of the contact holes varies in accordance with the width of the wires and, thereby, the same working effects as of the fifth invention can be gained and the limitation value can be microscopically adjusted with a high precision in accordance with the width/area of the wires.

The semiconductor device layout inspection method according to the tenth invention is a method for inspecting formation defects that will occur in wires of a chip layout, comprising: the step of dividing the entire area of the chip layout into a plurality of inspection regions; and the step of providing limitation to the number of the contact holes in the wires having a constant width in an inspection region from among the plurality of inspection regions so that a wire formation defect is detected by determining the existence of a defect based on this number limitation, wherein the step of detecting a wire formation defect is repeated in a scanning manner until the plurality of inspection regions on the entire surface of the chip layout is inspected.

According to the tenth invention, the step of dividing the entire area of the chip layout into a plurality of inspection regions; and the step of providing limitation to the number of the contact holes in the wires having a constant width in an inspection region from among the plurality of inspection regions so that a wire formation defect is detected by determining the existence of a defect based on this number limitation are provided, wherein the step of detecting a wire formation defect is repeated in a scanning manner until the plurality of inspection regions on the entire surface of the chip layout is inspected and, therefore, the same inspection as of the fourth invention is carried out in an inspection region and such an inspection is repeated for every inspection region, the total of which covers the entire surface so that the inspection of the entire surface of the layout is completed. A local portion wherein contacts are located in a high density can be inspected so as to avoid a formation defect by dividing the entirety of the chip into regions in contrast to the inspection of the entire surface of the chip.

The entire surface inspection for inspecting the entire chip surface of the chip layout and a partial inspection for inspecting a portion of a chip may have different scanning intervals of the inspection regions in the configuration of the tenth invention.

Thus the entire surface inspection for inspecting the entire chip surface of the chip layout and a partial inspection for inspecting a portion of a chip may have different scanning intervals of the inspection regions and, therefore, an appropriate scanning interval can be selected in accordance with a purpose such that the processing turn around time (hereinafter abbreviated as TAT) is prioritized for the inspection of the entire surface of the chip and a detailed inspection is prioritized for a partial inspection.

The entire surface inspection for inspecting the entire chip surface of the chip layout and a partial inspection for inspecting a portion of the chip may have different sizes of the inspection regions in the configuration of the tenth invention.

Thus, an appropriate size of the inspection region can be selected in accordance with a purpose such that the processing TAT is prioritized for the inspection of the entire chip surface and a detailed inspection is prioritized for a partial inspection.

It is preferable to provide limitation to the number of the contact holes in wires having a constant width after wires connected to contact holes of which the number is less than a constant number in the chip layout has been removed in advance in the configuration of the fourth invention.

Thus, limitation is provided to the number of the contact holes in wires having a constant width after wires connected to contact holes of which the number is less than a constant number in the chip layout has been removed in advance and, therefore, the minimum number of contact holes in the wires having a certain possibility of the occurrence of defects is defined so that the wires which do not require inspection are removed in accordance with the number of contact holes before the number limitation of the contact holes is provided in the same manner as in the fourth invention and, thereby, the process TAT can be shortened.

It is preferable to provide limitation to the number of the contact holes in wires having a constant width in inspection regions that have been limited to the inspection regions having contact holes of which the number is equal to, or greater than, a constant number from among the plurality of inspection regions in the configuration of the tenth invention.

Thus, limitation is provided to the number of the contact holes in wires having a constant width in inspection regions that have been limited to the inspection regions having contact holes of which the number is equal to, or greater than, a constant number from among the plurality of inspection regions and, therefore, the number limitation of the contact holes can be carried out in the same manner as in the tenth invention without selecting inspection regions which do not require inspections in accordance with the number of contact holes so that the processing TAT can be shortened.

The semiconductor device layout inspection method according to the eleventh invention is a method for inspecting formation defects that will occur in wires of a chip layout, comprising: the step of dividing the entire area of the chip layout into a plurality of inspection regions; and the step of providing limitation to the area ratio of the total area of the wires of the same node to the total area of the contact holes in the wires of the same node using an antenna check in an inspection region from among the plurality of inspection regions so that a wire formation defect is detected by determining the existence of a defect based on this limitation, wherein the step of detecting a wire formation defect is repeated in a scanning manner until the plurality of inspection regions on the entire surface of the chip layout is inspected.

According to the eleventh invention the step of dividing the entire area of the chip layout into a plurality of inspection regions; and the step of providing limitation to the area ratio of the total area of the wires of the same node to the total area of the contact holes in the wires of the same node using an antenna check in an inspection region from among the plurality of inspection regions so that a wire formation defect is detected by determining the existence of a defect based on this limitation, are provided wherein the step of detecting a wire formation defect is repeated in a scanning manner until the plurality of inspection regions on the entire surface of the chip layout is inspected and, therefore, the same inspection as in the second invention is carried out in an inspection region and such an inspection is repeated in a scanning manner for every inspection regions of which the total covers the entire surface so that the inspection of the entire surface of the layout is completed. Therefore, formation defects such as wire disconnections, breakdowns and peelings from the surface of the wires of a large area due to hillocks and failures in connections between the wires and contact holes can be avoided. In addition, the ratio of the conventional gates to the contacts connected to the gates is calculated according to the antenna check, which can be applied to the above inspection by using wires instead of the gates.

The semiconductor device layout inspection method according to the twelfth invention is a method for inspecting formation defects that will occur in wires of a chip layout, comprising: the step of defining a partial inspection region in the chip layout; and the step of providing limitation to the area ratio of the total area of the wires of the same node to the total area of the contact holes in the wires of the same node using an antenna check in the partial inspection region so that a wire formation defect is detected by determining the existence of a defect based on this limitation, wherein the step of detecting a wire formation defect is repeated in a scanning manner using a density check until the total of partial inspection regions cover the entire surface of the chip layout.

According to the twelfth invention the step of defining a partial inspection region in the chip layout; and the step of providing limitation to the area ratio of the total area of the wires of the same node to the total area of the contact holes in the wires of the same node using an antenna check in the partial inspection region so that a wire formation defect is detected by determining the existence of a defect based on this limitation are provided, wherein the step of detecting a wire formation defect is repeated in a scanning manner using a density check until the total of partial inspection regions cover the entire surface of the chip layout and, therefore, the same inspection as in the second invention is carried out within a partial inspection region and such an inspection is repeated in a scanning manner for every partial inspection region of which the total covers the entire surface and, thereby, the inspection of the entire surface of the layout is completed. Thus, formation defects such as wire disconnections, breakdowns and peelings from the surface of the wires of a large area due to hillocks and failures in connections between the wires and contact holes can be avoided. In addition, the ratio of the conventional gates to the contacts connected to the gates is calculated according to the antenna check, which can be applied to the above inspection by using wires instead of the gates.

### BRIEF DESCRIPTION OF THE DRAWINGS

FIG. 1 is a layout diagram showing wire and contact hole layers in a semiconductor layout utilized for an embodiment of this invention;

FIG. 2 is a dataflow diagram showing a flow of data at the time of inspection according to the first embodiment of this invention;

FIG. 3 is a flowchart showing an inspection algorithm according to the first embodiment of this invention;

FIGS. 4A, 4B, 4C and 4D are diagrams showing an inspection process according to the first embodiment of this invention;

FIG. 5 is a dataflow diagram showing a flow of data at the time of inspection according to the second embodiment of this invention;

FIG. 6 is a flowchart showing an inspection algorithm according to the second embodiment of this invention;

FIGS. 7A, 7B, 7C and 7D are diagrams showing an inspection process according to the second embodiment of this invention;

FIG. 8 is a dataflow diagram showing a flow of data at the time of inspection according to the third embodiment of this invention;

FIG. 9 is a flowchart showing an inspection algorithm according to the third embodiment of this invention;

FIGS. 10A, 10B, 10C and 10D are diagrams showing an inspection process according to the third embodiment of this invention;

FIG. 11 is a dataflow diagram showing a flow of data at the time of inspection according to the fourth embodiment of this invention;

FIG. 12 is a flowchart showing an inspection algorithm according to the fourth embodiment of this invention;

FIGS. 13A, 13B, 13C and 13D are diagrams showing an inspection process according to the fourth embodiment of this invention;

FIG. 14 is a dataflow diagram showing a flow of data at the time of inspection according to the fifth embodiment of this invention;

FIG. 15 is a flowchart showing an inspection algorithm according to the fifth embodiment of this invention;

FIGS. 16A, 16B, 16C, 16D and 16E are diagrams showing an inspection process according to the fifth embodiment of this invention;

FIG. 17 is a dataflow diagram showing a flow of data at the time of inspection according to the sixth embodiment of this invention;

FIG. 18 is a flowchart showing an inspection algorithm according to the sixth embodiment of this invention;

FIGS. 19A, 19B, 19C, 19D and 19E are diagrams showing an inspection process according to the sixth embodiment of this invention;

FIG. 20 is a dataflow diagram showing a flow of data at the time of inspection according to the seventh embodiment of this invention;

FIG. 21 is a flowchart showing an inspection algorithm according to the seventh embodiment of this invention;

FIGS. 22A, 22B, 22C, 22D and 22E are diagrams showing an inspection process according to the seventh embodiment of this invention;

FIG. 23 is a dataflow diagram showing a flow of data at the time of inspection according to the eighth embodiment of this invention;

FIG. 24 is a flowchart showing an inspection algorithm according to the eighth embodiment of this invention;

FIGS. 25A, 25B, 25C, 25D and 25E are diagrams showing an inspection process according to the eighth embodiment of this invention;

FIG. 26 is a dataflow diagram showing a flow of data at the time of inspection according to the ninth embodiment of this invention;

FIG. 27 is a flowchart showing an inspection algorithm according to the ninth embodiment of this invention;

FIGS. 28A, 28B, 28C and 28D are diagrams showing a region wherein the number of contact holes is collectively inspected according to the ninth embodiment of this invention;

FIGS. 29A, 29B, 29C, 29D and 29E are diagrams showing an inspection process according to the ninth embodiment of this invention;

FIGS. 30A, 30B, 30C, 30D, 30E and 30F are diagrams showing an inspection process according to the ninth embodiment of this invention;

FIG. 31 is a dataflow diagram showing a flow of data at the time of inspection according to the tenth embodiment of this invention;

FIG. 32 is a flowchart showing an inspection algorithm according to the tenth embodiment of this invention;

FIGS. 33A, 33B, 33C, 33D and 33E are diagrams showing an inspection process according to the tenth embodiment of this invention;

FIG. 34 is a dataflow diagram showing a flow of data at the time of inspection according to the eleventh embodiment of this invention;

FIG. 35 is a flowchart showing an inspection algorithm according to the eleventh embodiment of this invention;

FIGS. 36A, 36B, 36C and 36D are diagrams showing a region wherein the number of contact holes is collectively inspected according to the eleventh embodiment of this invention;

FIGS. 37A, 37B, 37C, 37D and 37E are diagrams showing an inspection process according to the eleventh embodiment of this invention;

FIGS. 38A, 38B, 38C and 38D are diagrams showing an inspection process according to the eleventh embodiment of this invention;

FIGS. 39A, 39B, 39C, 39D and 39E are diagrams showing an inspection process according to the eleventh embodiment of this invention;

FIG. 40 is a dataflow diagram showing a flow of data at the time of inspection according to the twelfth embodiment of this invention;

FIG. 41 is a flowchart showing an inspection algorithm according to the twelfth embodiment of this invention;

FIGS. 42A, 42B, 42C and 42D are diagrams showing a region wherein the number of contact holes is collectively inspected according to the eleventh embodiment of this invention;

FIGS. 43A, 43B, 43C and 43D are diagrams showing an inspection process according to the twelfth embodiment of this invention;

FIG. 44 is a dataflow diagram showing a flow of data at the time of inspection according to the thirteenth embodiment of this invention;

FIG. 45 is a flowchart showing an inspection algorithm according to the thirteenth embodiment of this invention; and

FIGS. 46A, 46B, 46C and 46D are diagrams showing an inspection process according to the thirteenth embodiment of this invention.

### DETAILED DESCRIPTION OF THE PREFERRED EMBODIMENTS

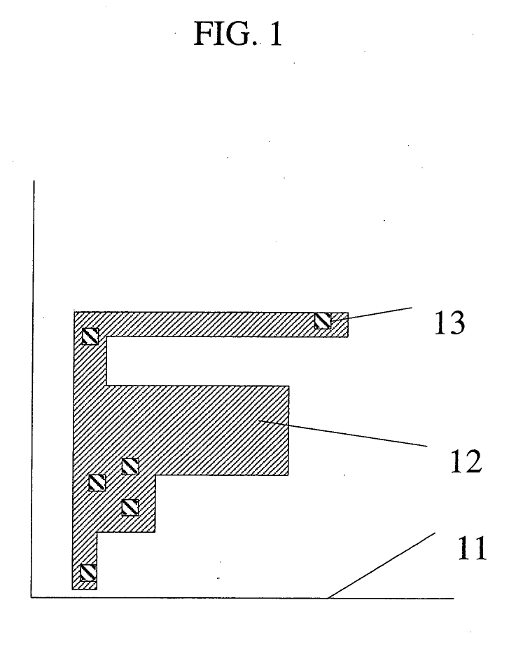

The first embodiment of this invention is described below in reference to FIGS. 1, 2, 3, 4A, 4B, 4C and 4D.

FIG. 1 is a layout diagram showing wire and contact hole layers in a semiconductor layout that is used for the embodiment of this invention.

In FIG. 1, symbol 11 indicates the outermost periphery of a chip, symbol 12 indicates a layout of a wire layer and symbol 13 indicates a layout of a contact hole layer.

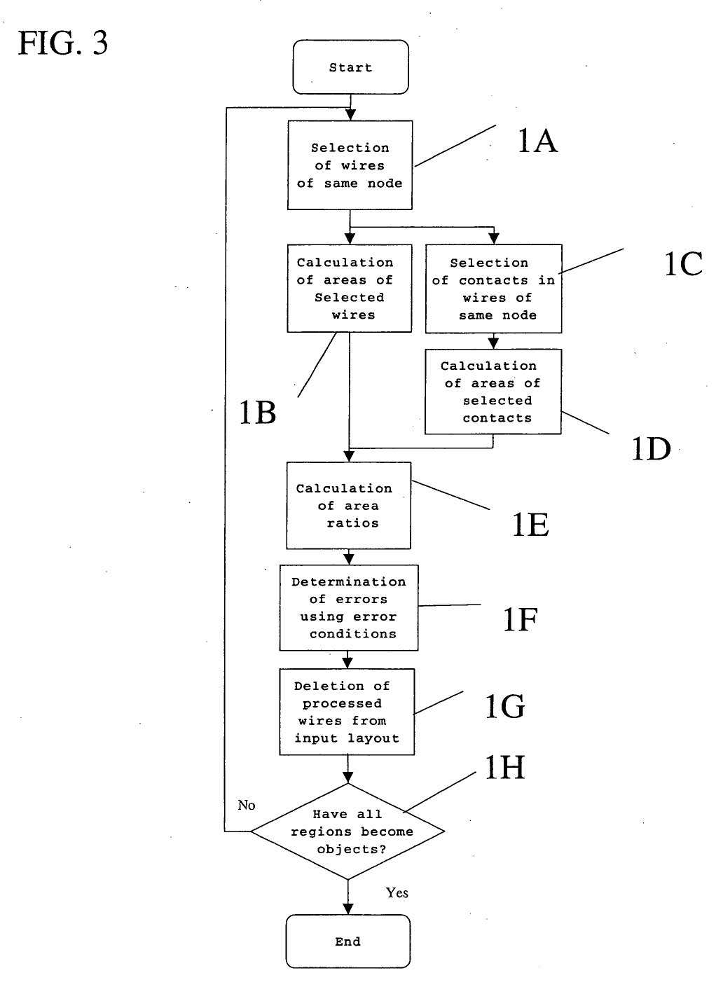

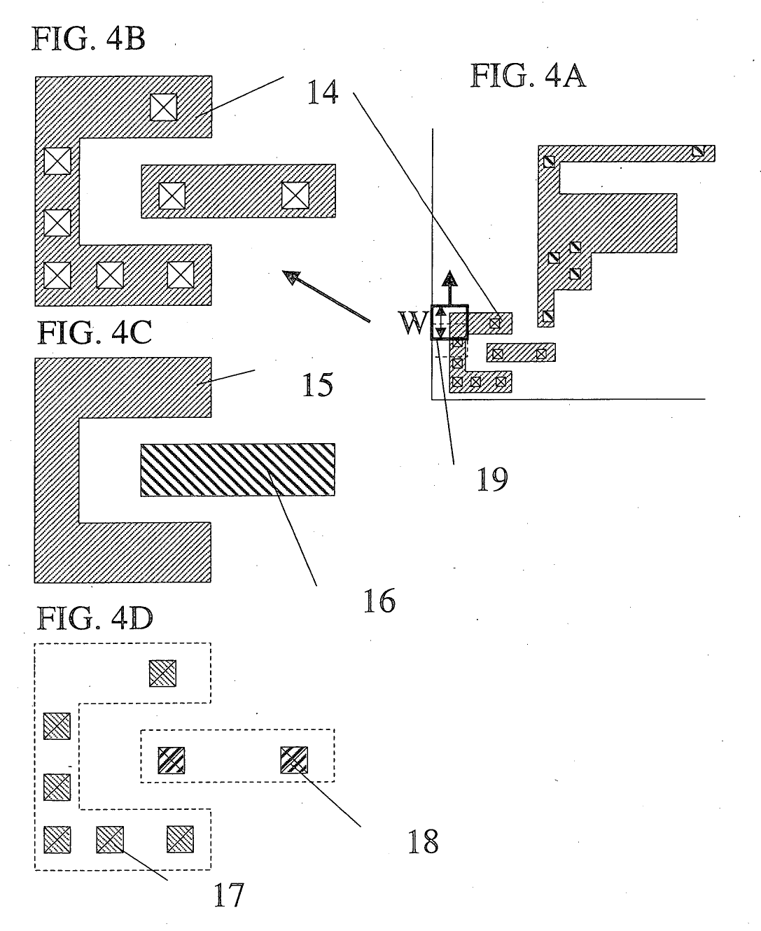

FIG. 3 is a flowchart showing an inspection algorithm according to the first embodiment of this invention and FIGS. 4A, 4B, 4C and 4D are diagrams showing an inspection process according to the first embodiment of this invention. In the following, the inspection process is described in reference to the flowchart.

This semiconductor device layout inspection method is a method for inspecting formation defects that will occur in wires of a large area in a chip layout, wherein the area ratio of the total area of the wires of the same node to the total area of the contact holes in the wires of the same node is limited in the chip layout and the wire formation defects are detected by determining whether or not defects exist based on this limitation.

In this case, as shown in FIGS. 4A, 4B and 4C, a region 19 having four sides of the minimum wire interval W is defined in a layout 14 and a wire 15 which region 19 overlaps is selected from among the wires in layout 14. Since region 19 has the minimum wire interval, the selected wire 15 always becomes of the same node. In the case wherein region 19 does not overlap the wire of layout 14, region 19 is shifted by minimum wire interval W so as not to overlap the previous position within layout 14 and the next region is selected and it is determined whether or not the selected region overlaps the wire layer of layout 14. The determination is repeated (Step 1A) until the entire surface of the layout has completely be scanned or the next wire of the same node has been found.

The area of the selected wire 15 of the same node is calculated (Step 1B). Wire 15 having a contact hole 17 and wire 16 having a contact hole 18 are of different nodes (FIG. 4D). Contact hole 17 that overlaps wire 15 selected in step 1A is selected (Step 1C). The total area of contact hole 17 selected in step 1C is calculated (Step 1D). The area ratio is calculated (Step 1E) from the area of wire 15 of the same node that has been calculated in step 1B and from the total area of contact hole 17 that has been calculated in step 1D. At this time, contact hole 17 and contact hole 18 are located in wires of different nodes and, therefore, the area ratios are separately calculated. In the case wherein the area ratio of step 1E becomes equal to, or greater than, the limitation value, the area is detected as an error portion where wire formation defects occur (Step 1F).

Next, wires that have been selected in step 1A are eliminated from input layout 14 (Step 1G). Wires of the same node that have once been selected in step 1G are eliminated from input layout 14 so as not to be selected twice and, therefore, a high speed CAD process can be implemented. It is determined (Step 1H) whether or not region 19 selected in step 1A has scanned the entire surface of the input layout. The procedure returns to step 1A so as to be repeated in the case wherein region 19 that has not been scanned exists. The inspection is completed after the entire surface has been scanned.

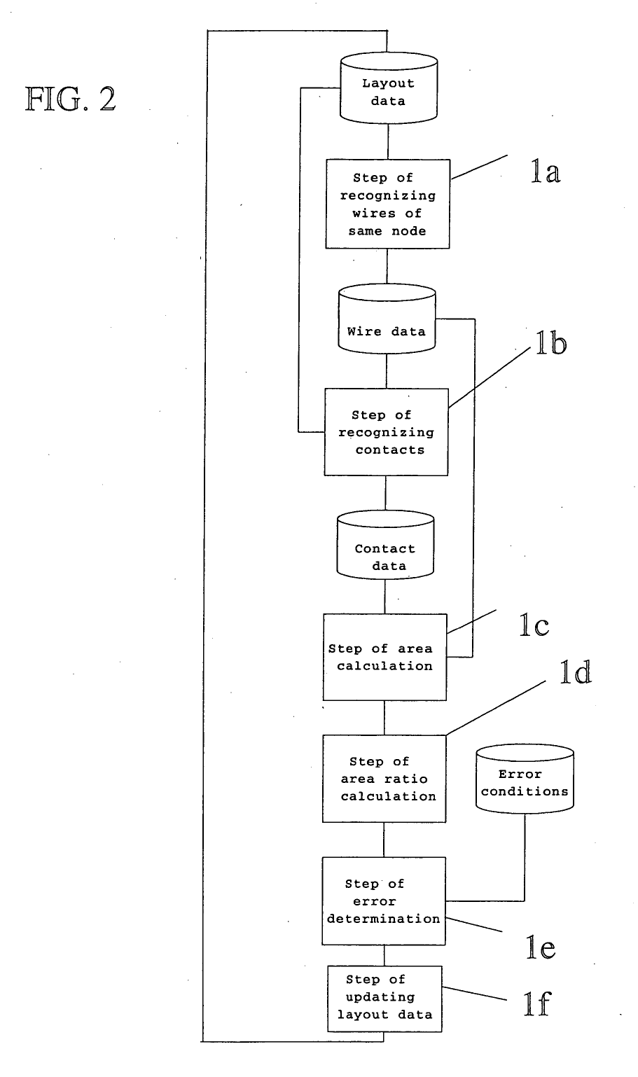

FIG. 2 is a dataflow diagram showing a flow of data at the time of inspection according to the first embodiment of this invention. In the following the dataflow is described.

As shown in FIG. 2, wire data 15 is selected and outputted as the same node in the case wherein a region that overlaps wire data 15 of the inputted layout data 14 exists in same node wire recognition step 1a wherein a region 19 of the minimum wire interval is defined. The selected wire data 15 and layout data 14 are inputted in contact recognition step 1b so that contact hole data 17 in layout data 14 that overlaps wire data 15 is selected and outputted. The selected same node wire data 15 and the selected contact hole data 17 are inputted in area calculation step 1c so that the respective total areas are calculated. The area ratio of the area of same node wire data 15 to the area of contact hole data 17 is calculated and outputted in area ratio calculation step 1d, wherein the respective areas have been calculated in area calculation step 1c.

The selected wire data 15 and contact hole data 17 are outputted as errors in the case wherein the area ratio and the error conditions are compared and the area ratio does not satisfy the conditions in error determination step 1e. Layout data 14 and wire data 15 are inputted in layout data update step 1f and the layout data gained by subtracting wire data 15 that has been selected in same node wire recognition step 1a from input layout data 14 is output and this outputted data is used as input layout data for the wires to be inspected next.

As a result of the above described procedure locations wherein wire formation defects occur in the input layout can be detected.

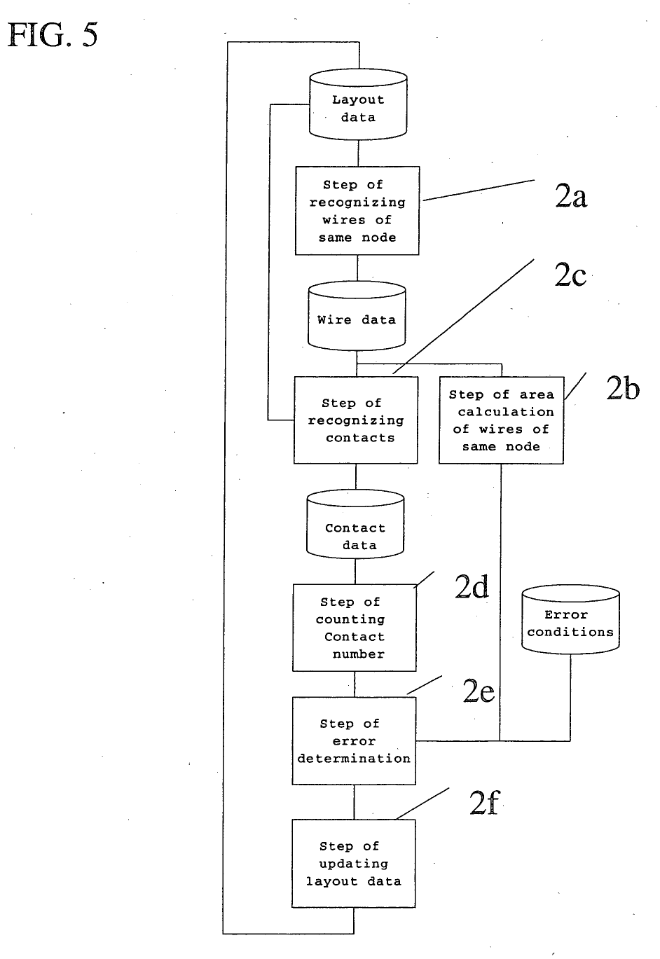

The second embodiment of this invention is described based on FIGS. 5, 6, 7A, 7B, 7C and 7D.

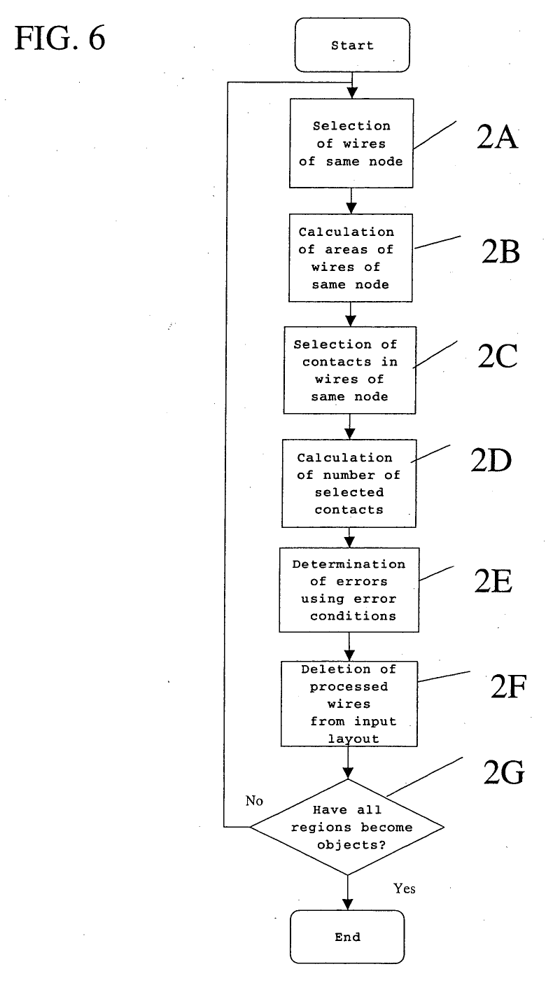

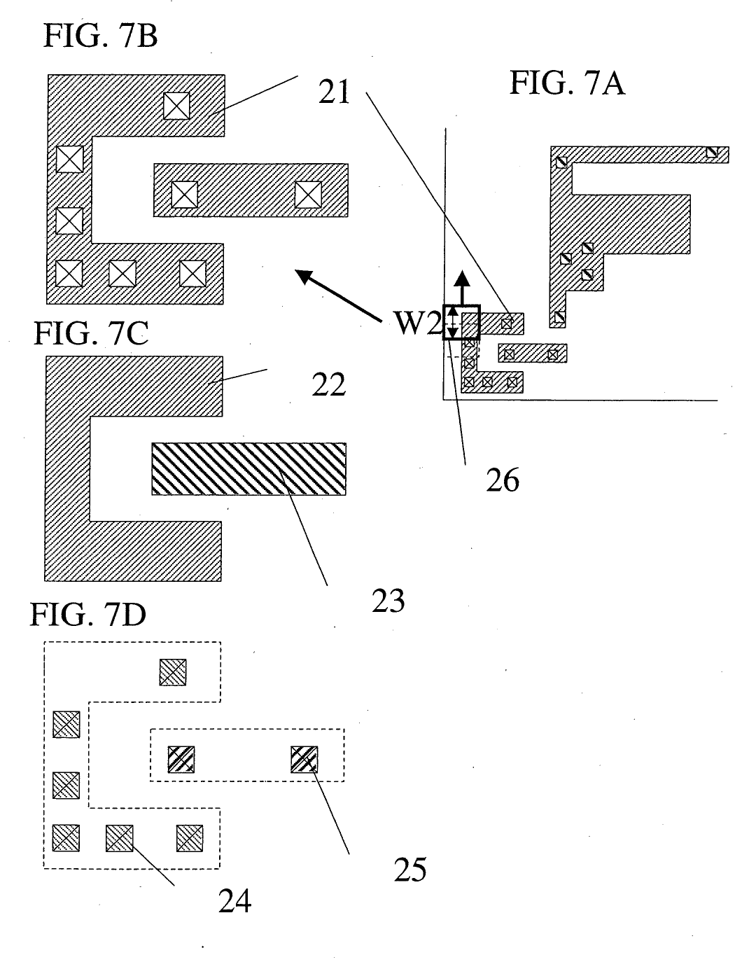

FIG. 6 is a flowchart showing the inspection algorithm according to the second embodiment of this invention and FIGS. 7A, 7B, 7C and 7D are diagrams showing the inspection process according to the second embodiment of this invention. In the following the inspection procedure is described in accordance with the flowchart.

This semiconductor device layout inspection method is a method for inspecting formation defects that occur to large area wires in the chip layout wherein the number of contact holes in wires of the same node is limited and the existence of defects is determined based on this number limitation and, thereby, the locations of wire formation defects are detected.

In this case, as shown in FIGS. 7A, 7B and 7C, a region 26 with four sides having the minimum wire interval W2 is defined in layout 21 and wire 22 overlapped by region 26 is selected from among the wires in layout 21. Region 26 has the minimum wire interval and, therefore, the selected wire 22 always has the same node. In the case wherein region 26 does not overlap any wires in layout 21, region 26 is shifted by minimum wire interval W2 so that region 26 does not overlap the previous position in layout 21 and, then, the next region is selected and it is determined whether or not the selected region overlaps the wire layer of layout 21. The determination is repeated (Step 2A) until the scanning of the entire surface of the layout is completed or the next wire of the same node is found.

The area of the selected wire 22 of the same node is calculated (Step 2B). Contact hole 24 that overlaps the calculated wire 22 of the same node is selected (Step 2C). At this time, wire 22 that has contact hole 24 and wire 23 that has contact hole 25 are of different nodes (FIG. 7D). The number of contact holes 24 that has been selected in step 2C is calculated (Step 2D). In the case wherein the number of contact holes 24 that has been calculated in step 2D is equal to, or greater than, the limitation value that has been determined in advance according to the area of wires 22 of the same node, the area is detected as an error portion where wire formation defects occur (Step 2E).

Next, wires that have been selected in step 2A are eliminated from input layout 21 (Step 2F). The wires of the same node that have once been selected in step 2F are eliminated from input layout 21 and are not selected again and, therefore, a high speed CAD process can be implemented. It is determined whether or not region 26 selected in step 2A has scanned the entire surface of input layout 21 (Step 2G). In the case wherein region 26 that has not been scanned exists, the procedure returns to step 2A and is repeated. The inspection is completed after scanning the entire surface.

FIG. 5 is a dataflow diagram showing a flow of data at the time of inspection according to the second embodiment of this invention. In the following the dataflow is described.

As shown in FIG. 5, minimum wire interval region 26 is selected in same node wire recognition step 2a and wire data 22 is selected and outputted as of the same node in the case wherein a region exists that overlaps wire data 22 of the inputted layout data 21. The selected wire data 22 is inputted in same node area calculation step 2b so as to calculate area and the calculation value is outputted. Input layout data 21 and wire data 22 that has been outputted in same node wire recognition step 2a are inputted in contact recognition step 2c so that contact hole data 24 in input layout data 21 that overlaps wire data 22 is selected and outputted. The number of pieces of contact hole data 24 that has been outputted in contact recognition step 2c is calculated and outputted in contact number count step 2d.

The area of same node wire data 22 that has been outputted in area calculation step 2b and the number of pieces of contact hole data 24 that has been outputted in contact number count step 2d are inputted in error determination step 2e and wire data 22 and contact hole data 24 that have been selected as errors are outputted in the case wherein the number of contact holes relative to the area does not satisfy the condition. Layout data 21 and wire data 22 are inputted in layout data update step 2f wherein the layout data gained by subtracting selected wire data 22 from the wire layer of input layout data 21 is outputted so that this outputted data is used as the input layout data for wires that are inspected next.

As a result of the above described procedure location where wire formation defects occur can be detected in the input layout.

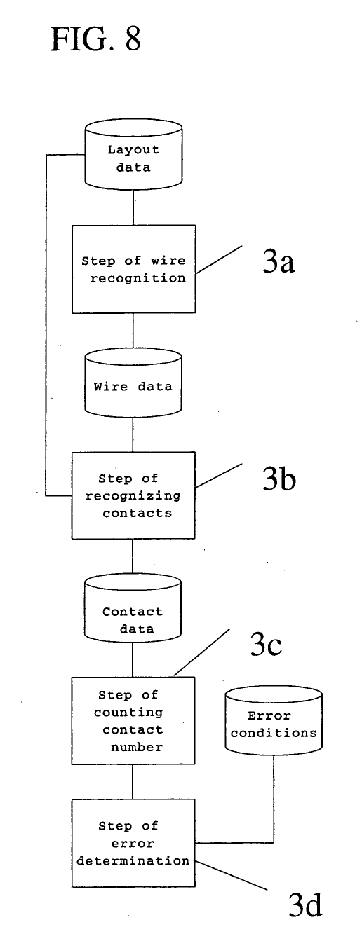

The third embodiment of this invention is described below in reference to FIGS. 8, 9, 10A, 10B, 10C and 10D.

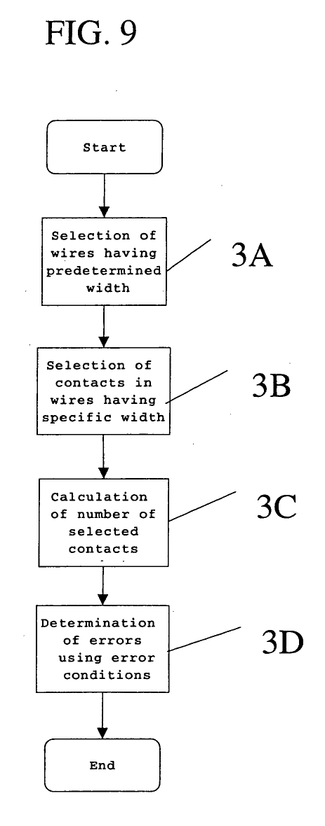

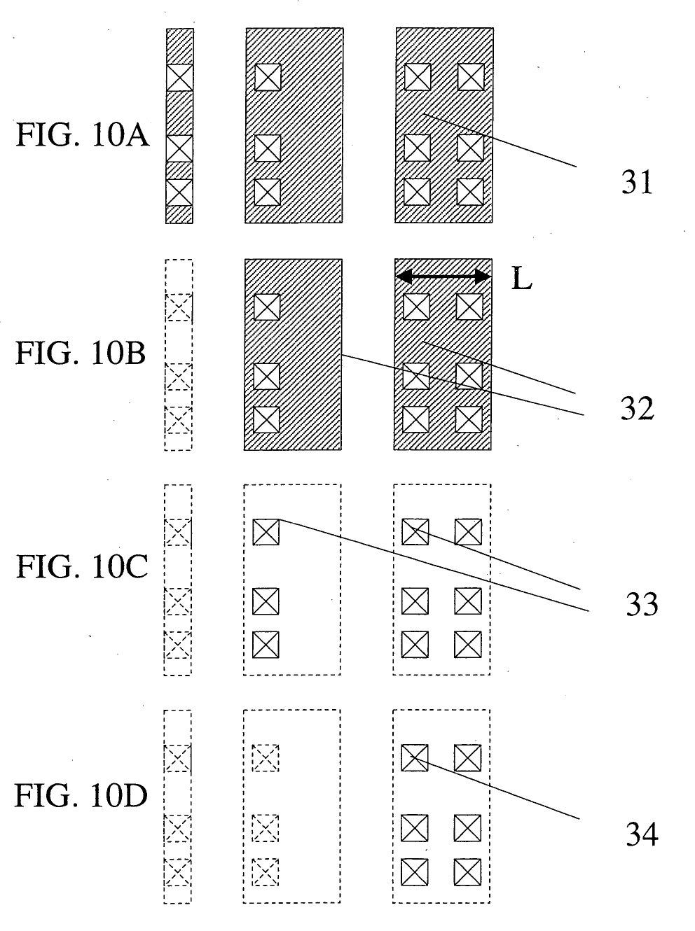

FIG. 9 is a flowchart showing the inspection algorithm according to the third embodiment of this invention and FIGS. 10A, 10B, 10C and 10D are diagrams showing the inspection process according to the third embodiment of this invention. In the following the inspection procedure is described in accordance with the flowchart.

This semiconductor device layout inspection method is a method for inspecting formation defects that will occur in large area wires in a chip layout, wherein the number of contact holes in wires having a constant width is limited and the existence of defects is determined based on this number limitation and, thereby, wire formation defects are detected.

In this case, as shown in FIGS. 10A and 10B, wires 32 having wire width that are equal to, or greater than, wire width L wherein the possibility of the existence of wire formation defects is considered to be high in layout 31 are selected (Step 3A). As shown in FIGS. 10C and 10D, contact holes 33 that overlap wires 32 selected in step 3A are selected (Step 3B). The number of contact holes 33 that have been selected in step 3B is calculated (Step 3C). Error layout 34 is detected (Step 3D) using the number limit (for example, four or greater) that has been set depending on wire width L.

FIG. 8 is a dataflow diagram showing a flow data at the time of the inspection according to the third embodiment of this invention. In the following the dataflow is described.

As shown in FIG. 8, wire width L that is considered to have a high possibility of wire formation defects is in advance defined in wire recognition step 3a and wire data 32 of wires having a width that is equal to, or greater than, wire width L is selected from among the inputted layout data 31 so that the selected data is outputted. Wire data 32 that has been outputted in wire recognition step 3a and input layout data 31 are inputted in contact recognition step 3b and contact hole data 33 that overlaps wire data 32 is selected from input layout data 31 so that the selected data is outputted. Contact hole data 33 that has been outputted in contact recognition step 3b is entered so that the number of contact holes is calculated and outputted in contact number counter step 3c.

The number of pieces of contact hole data 33 that has been outputted in contact number count step 3c is inputted so as to output error layout data 34 corresponding to the number limit (for example, four or greater) that has been set depending on wire width L in error determination step 3d.

As a result of the above described procedure, locations wherein wire formation defects occur can be detected in the input layout.

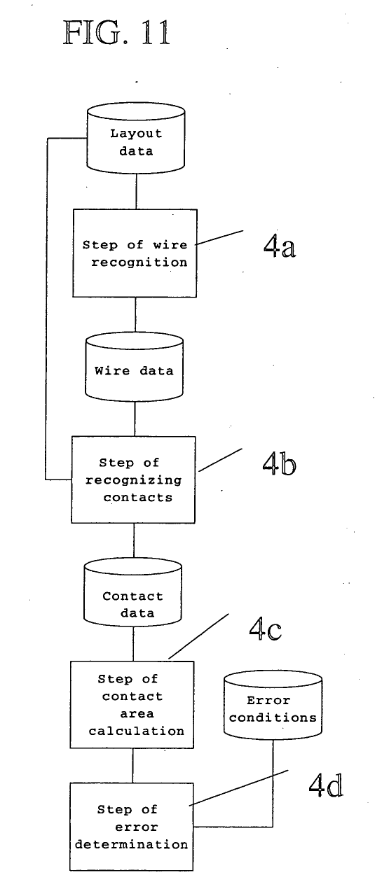

The fourth embodiment of this invention is described below in reference to FIGS. 11, 12, 13A, 13B, 13C and 13D.

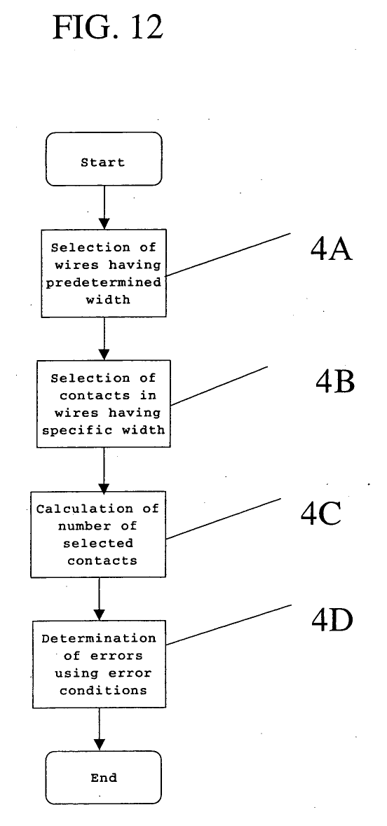

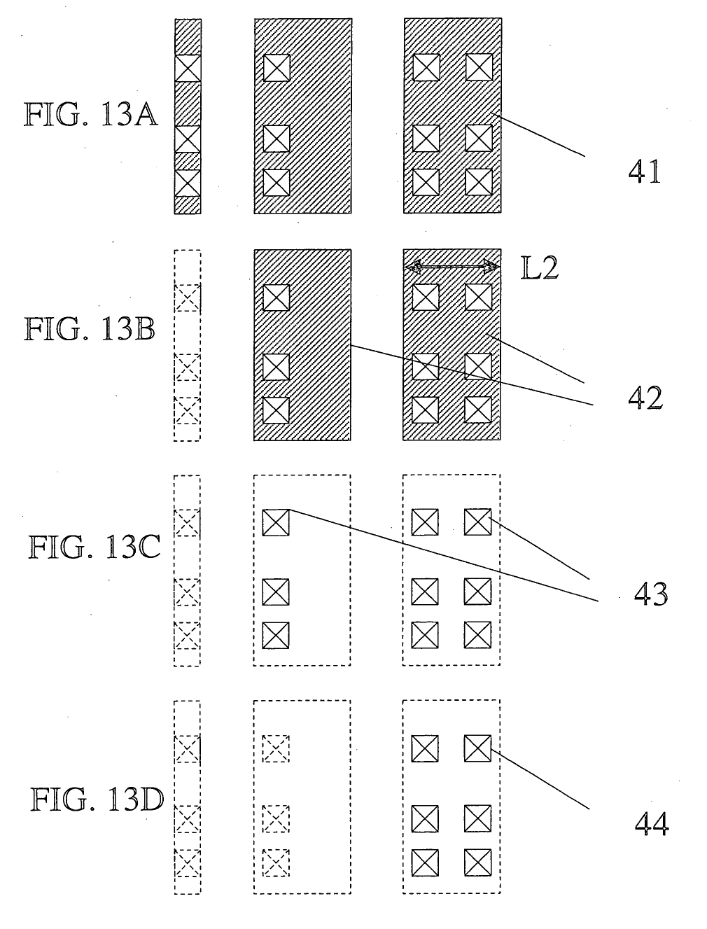

FIG. 12 is a flowchart showing an inspection algorithm according to the fourth embodiment of this invention and FIGS. 13A, 13B, 13C and 13D are diagrams showing the inspection process of the fourth embodiment of this invention. In the following the inspection procedure is described in accordance with the flowchart.

This semiconductor device layout inspection method is a method for inspecting formation defects that will occur in large area wires in a chip layout, wherein the total area of the contact holes in wires of a constant width is limited and existence of defects is determined based on this area limitation and, thereby, wire formation defects are detected.

In this case, as shown in FIGS. 13A and 13B, wires 42 having widths that are equal to, or greater than, wire width L2 and having a high possibility of occurrence of wire formation defects are selected in advance (Step 4A). As shown in FIGS. 13C and 13D, contact holes 43 that overlap wires 42 selected in step 4A are selected (Step 4B). The areas of contact holes 43 selected in step 4B are calculated (Step 4C). Error layout 44 is detected using the area limitation that has been set depending on wire width L2 (Step 4D).

FIG. 11 is a dataflow diagram showing a flow of data at the time of the inspection according to the fourth embodiment of this invention. In the following the dataflow is described.

As shown in FIG. 11, wire width L2 that is considered to have a high possibility of wire formation defects is in advance defined in wire recognition step 4a wherein wire data 42 of wires having wire widths that are equal to, or greater than, wire width L2 is selected from the inputted layout data 41 so that the selected is outputted. Wire data 42 that has been outputted in wire recognition step 4a and input layout data 41 are inputted in contact recognition step 4b and contact hole data 43 that overlaps wire data 42 is selected from input layout data 41 so that the selected data is outputted. Contact hole data 43 that has been outputted in contact recognition step 4b is inputted so as to calculate and output the total area of the contact holes in contact area calculation step 4c.

The total area of contact holes 43 that have been outputted in contact area calculation step 4c is inputted and error layout data 44, corresponding to the area limitation that is set depending on wire width L2, is outputted in error determination step 4d.

As a result of the above described procedure, locations wherein wire formation defects may occur in the input layout can be detected.

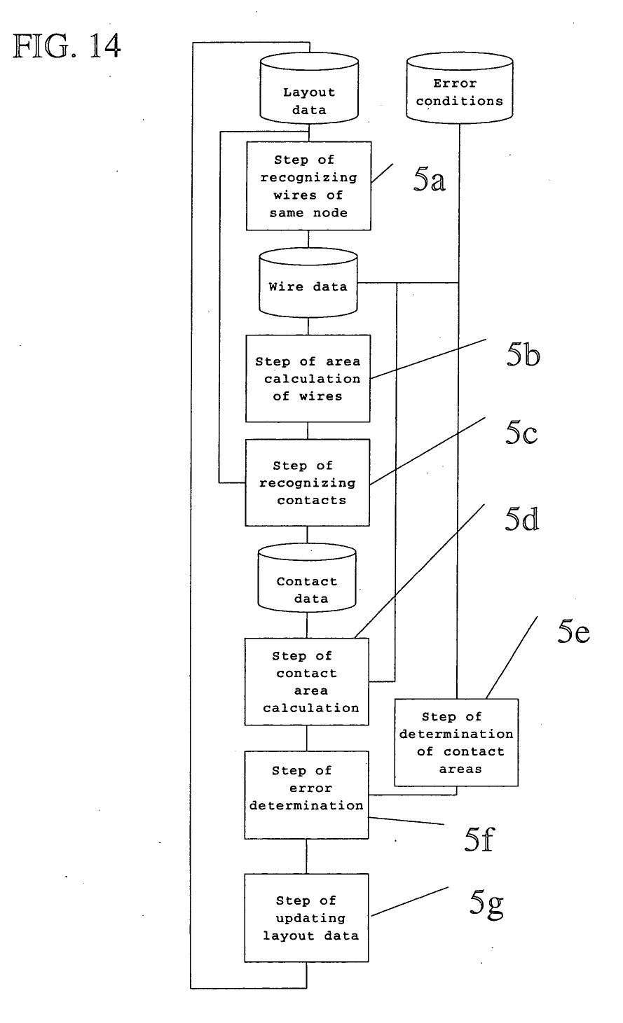

The fifth embodiment of this invention is described below in reference to FIGS. 14, 15, 16A, 16B, 16C, 16D and 16E.

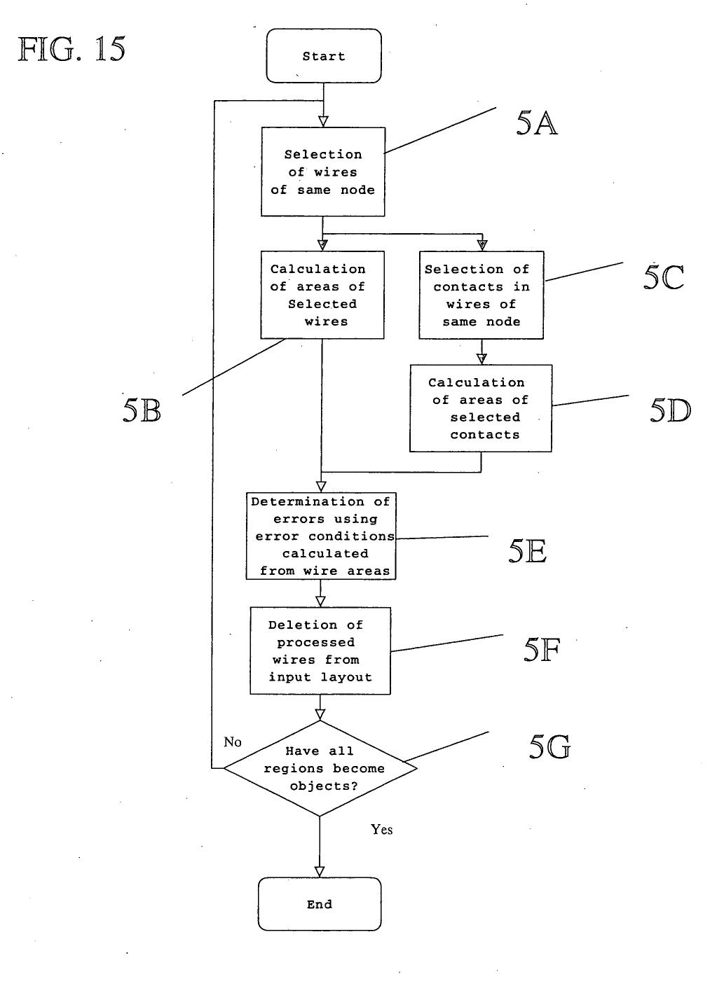

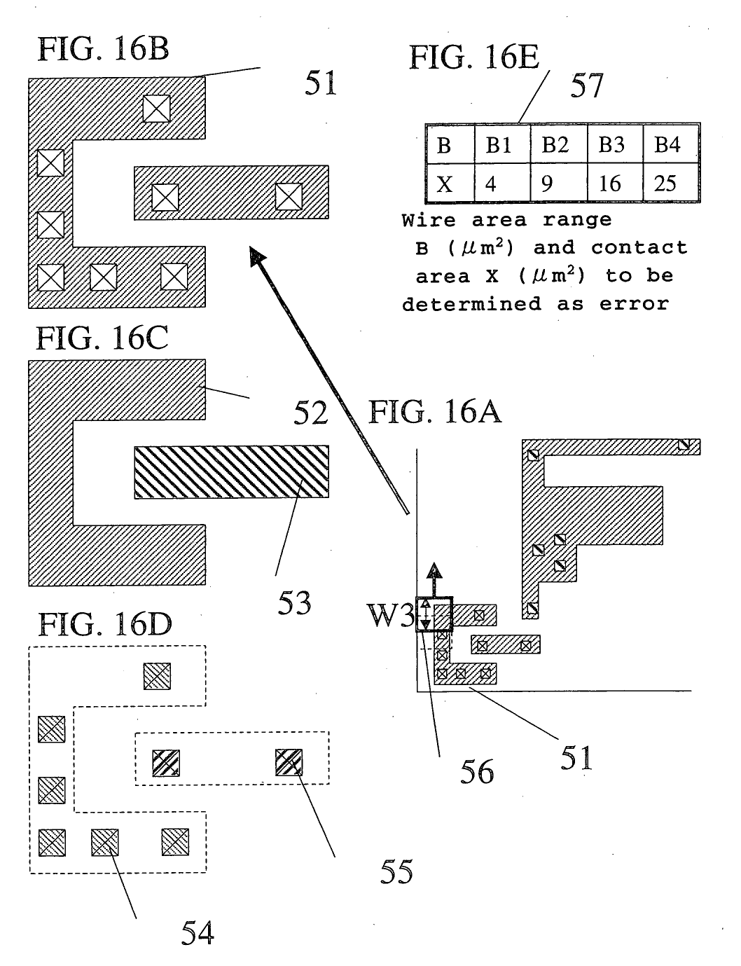

FIG. 15 is a flowchart showing the inspection algorithm according to the fifth embodiment of this invention and FIGS. 16A, 16B, 16C, 16D and 16E are diagrams showing the inspection process according to the fifth embodiment of this invention. In the following the inspection procedure is described according to the flowchart.

This semiconductor device layout inspection method is a method for inspecting formation defects that will occur in large area wires in the chip layout, comprising: the step of calculating the total area of wires of the same node and the total area of the contact hoes in the wires of the same node; and the step of determining the area limitation value of the contact holes in accordance with the total area of the wires of the same node, wherein the area of the same node is detected as wire formation defects when the total area of the contact holes is equal to, or greater than, the area limitation value.

In this case, as shown in FIGS. 16A, 16B and 16C, a region 56 with four sides having minimum wire interval W3 is defined in layout 51 and wire 52 overlapped by region 56 is selected from among the wires in layout 51. The selected wire 52 always becomes of the same node because region 56 has the minimum wire interval. In the case wherein region 56 does not overlap any wires in layout 51, region 56 is shifted by minimum wire interval W2 so as not to overlap the previous position in the layout and it is determined whether the selected next region overlaps the wire layer in layout 51. The determination is repeated until the entire surface of the layout has been scanned or until the next wire of the same node is discovered (Step 5A).

The area of the selected wire 52 of the same node is calculated (Step 5B). Wire 52 having a contact hole 54 and wire 53 having a contact hole 55 are of different nodes (FIG. 16D). Contact hole 54 that overlaps wire 52 selected in step 5A is selected (Step 5C). The total area of contact hole 54 selected in step 5C is calculated (Step 5D). A contact area limitation value X (μm²) in accordance with the range of wire area B (μm²) is uniquely determined from the area of wire 52 of the same node calculated in step 5B using table 57 of FIG. 16E. In the case wherein the determined limitation area X (μm²) and the total area of contact hole 54 calculated in step 5D are compared so as to find that the total area is equal to, or greater than, the limitation value X (μm²), the area is detected as an error wherein a wire formation defect has occurred (Step 5E).

Next, the wires selected in step 5A are deleted from input layout 51 (Step 5F). The wires of the same node that have once been selected in step 5F are deleted from input layout 51 so as not to be selected again and, therefore, a high speed CAD process can be implemented. It is determined whether or not region 56 selected in step 5A has scanned the entire surface of input layout 51 (Step 5G). In the case wherein there is a region 56 that has not been scanned, the procedure returns to step 5A so that the same steps are repeated. The inspection is completed as soon as the entire surface is scanned.

FIG. 14 is a dataflow diagram showing a flow of data at the time of inspection according to the fifth embodiment of this invention. In the following the dataflow is described.

As shown in FIG. 14, minimum wire interval region 56 is defined in step 5a of recognizing wires of the same node and in the case wherein there is a region that overlaps wire data 52 of the inputted layout data 51 wire data 52 is selected and outputted as of the same node. Wire data 52 that has been recognized in step 5a of recognizing wires of the same node is inputted in step 5b of calculating wire areas so that the area is calculated and the result is outputted. The selected wire data 52 and layout data 51 are inputted in contact recognition step 5c so that contact hole data 54 within layout data 51 that overlaps wire data 52 is selected and outputted. The selected contact hole data 54 is inputted in step 5d of calculating contact areas so as to calculated the total area. The contact area limitation value X (μm²) depending on wire area B (μm²) of error condition table 57 that has been prescribed in advance by the occurrence ratio of wire defects and wire area B (μm²) outputted in step 5b of calculating wire areas are inputted in step 5e of determining contact areas so that area limitation value X (μm²) is uniquely determined.

The limitation value X (μm²) of the contact area outputted in contact area determination step 5e and the contact area calculated in contact area calculation step 5d are inputted in error determination step 5f and, thereby, wire data 52 and contact hole data 54 that have been selected as errors in the case wherein the area is X (μm²) or greater are outputted. Layout data 51 and wire data 52 are inputted in layout data updating step 5g so as to output the layout data gained by subtracting selected wire data 52 from the wire layer of input layout data 51 is outputted and is used as input layout data of wires that are inspected next.

According to the above described procedure portions where wire formation defects may occur can be detected in the input layout.

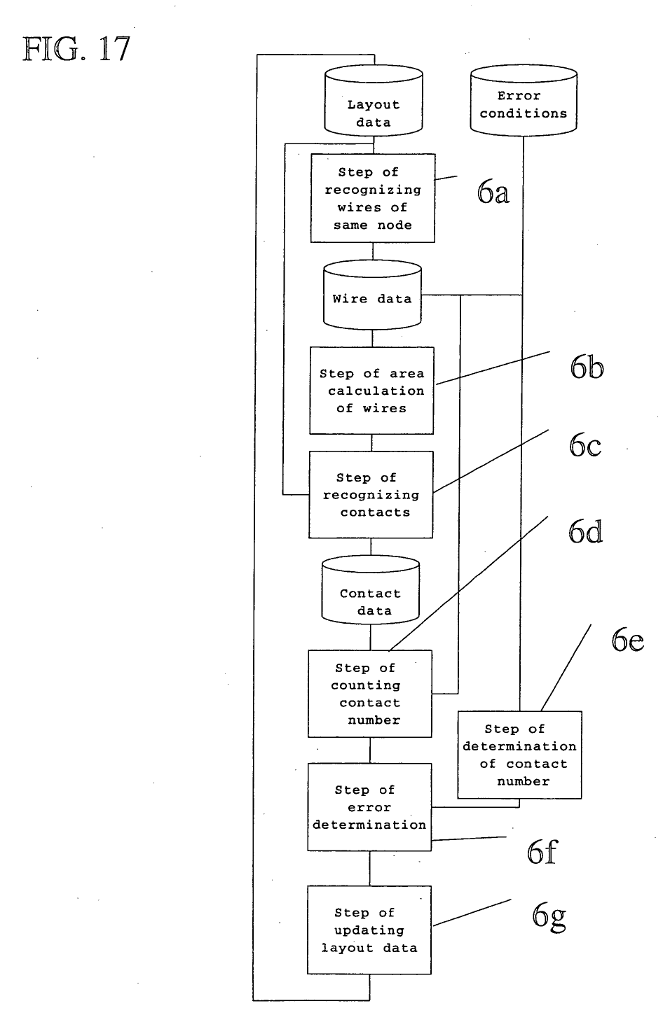

The sixth embodiment of this invention is described below in reference to FIGS. 17, 18, 19A, 19B, 19C, 19D and 19E.

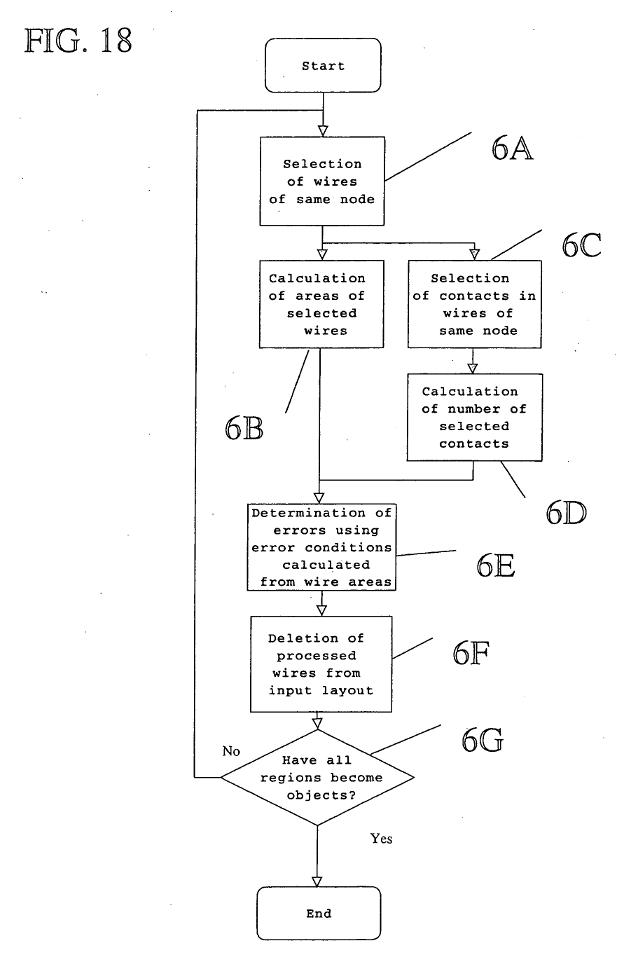

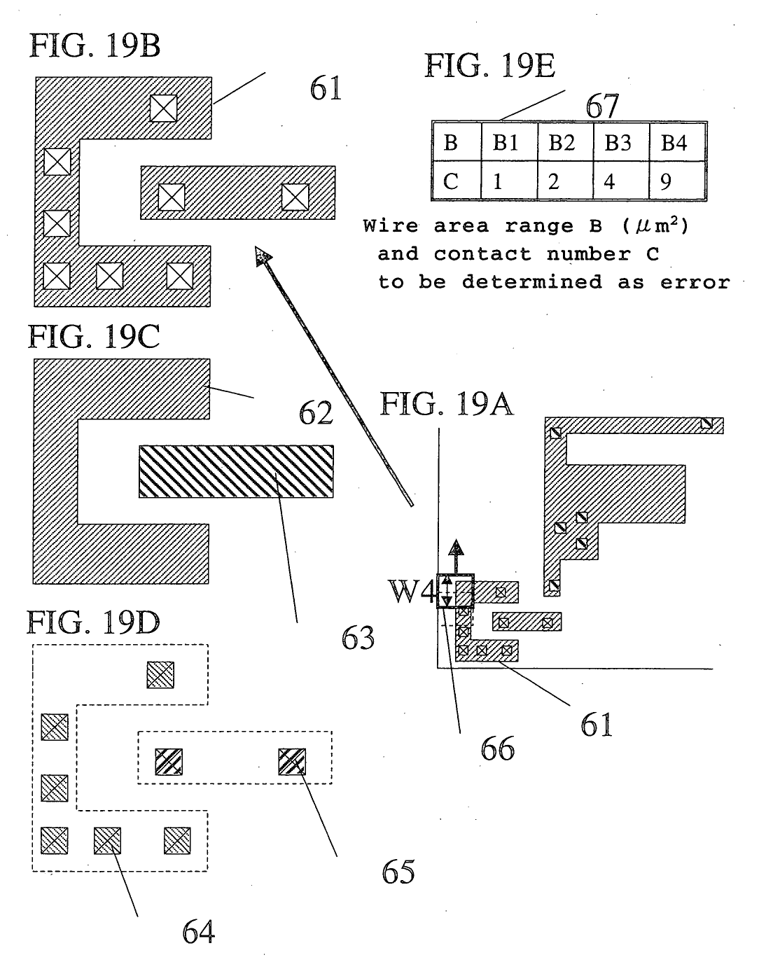

FIG. 18 is a flowchart showing an inspection algorithm of the sixth embodiment of this invention and FIGS. 19A, 19B, 19C, 19D and 19E are diagrams showing the inspection process of the sixth embodiment of this invention. In the following, the inspection procedure is described according to the flowchart.

This semiconductor device layout inspection method is a method for inspecting formation defects that occur in wires of a large area in a chip layout, which includes: the step of calculating the total area of wires of the same node and the number of contact holes in wires of the same node; and the step of determining the number limitation value of the contact holes in accordance with the total area of the wires of the same node, wherein wire formation defects are detected when the number of the contact holes is equal to, or greater than, the number limitation value.

In this case, as shown in FIGS. 19A, 19B and 19C, a region 66 having four sides of the minimum wire interval W4 is defined in layout 61 and wire 62 overlapped by region 66 is selected from among wires in layout 61. Region 66 has the minimum wire interval and, therefore, selected wire 62 always becomes of the same node. In the case wherein region 66 does not overlap any wires in layout 61, region 66 is shifted by minimum wire interval W4 so as not to overlap the previous position within the layout and it is determined whether or not the next selected region overlaps the wire layer of layout 61. The determination is repeated until the entire surface of the layout has been scanned or until the next wire of the same node is discovered (Step 6A).

The area of the selected wire 62 of the same node is calculated (Step 6B). Wire 62 having contact hole 64 and wire 63 having contact hole 65 are of different nodes (FIG. 19D). Contact holes 64 that overlap wire 62 selected in step 6A are selected (Step 6C). The number of contact holes 64 selected in step 6C is calculated (Step 6D). The contact number limitation value C in accordance with wire area B (μm²) is uniquely determined from the area of wire 62 of the same node calculated in step 6B using table 67 of FIG. 19E. The determined limitation number C and the number of contact holes 64 calculated in step 6D are compared and in the case that the number is equal to, or greater than C, the area is detected as an error where wire formation defects may occur (Step 6E).

Next, the wires selected in step 6A are deleted from the input layout (Step 6F). The wires of the same node that have been once selected in step 6F are deleted from the input layout so as not to be selected again and, therefore, a high speed CAD process can be implemented. It is determined whether or not region 66 selected in step 6A has scanned the entire surface of the input layout (Step 6G). In the case wherein there is a region 66 that has not been scanned, the procedure returns to step 6A so that the steps are repeated. The inspection is completed when the entire surface is scanned.

FIG. 17 is a dataflow diagram showing a flow of data at the time of inspection of the sixth embodiment of this invention. In the following, the dataflow is described.

As shown in FIG. 17, the minimum wire interval region 66 is defined in step 6a of recognizing wires of the same node and in the case wherein there is a region overlapped by wire data 62 of inputted layout data 61, wire data 62 is selected and outputted as of the same node. The same node wire data 62 recognized in step 6a of recognizing wires of the same node is inputted in step 6b of calculating wire areas and the area is calculated and the result is outputted. The selected wire data 62 and layout data 61 are inputted in contact recognition step 6c so as to select and output contact hole data 64 within layout data 61 that overlaps wire data 62. The contact hole data 64 selected in contact recognition step 6c is inputted in contact number counting step 6d so as to calculate the number. Error condition table 67 that has been prescribed in advance by occurrence ratio of wire defects and wire area B (μm²) outputted in wire area calculation step 6b are inputted in contact number determination step 6e wherein the contact number limitation value C depending on wire area B (μm²) is determined and outputted.

The limitation value C of the contact number outputted in contact number determination step 6e and the contact number calculated in contact number counting step 6d are inputted in error determination step 6f, wherein wire data 62 selected and contact hole data 64 are outputted as errors in the case that the number is equal to, or greater than C. Layout data 61 and wire data 62 are inputted in layout data update step 6g so that the layout data gained by subtracting selected wire data 62 from the wire layer of input layout data 61 is outputted and is used as input layout data of the next wire to be inspected.

According to the above described procedure portions where wire formation defects will occur can be detected.

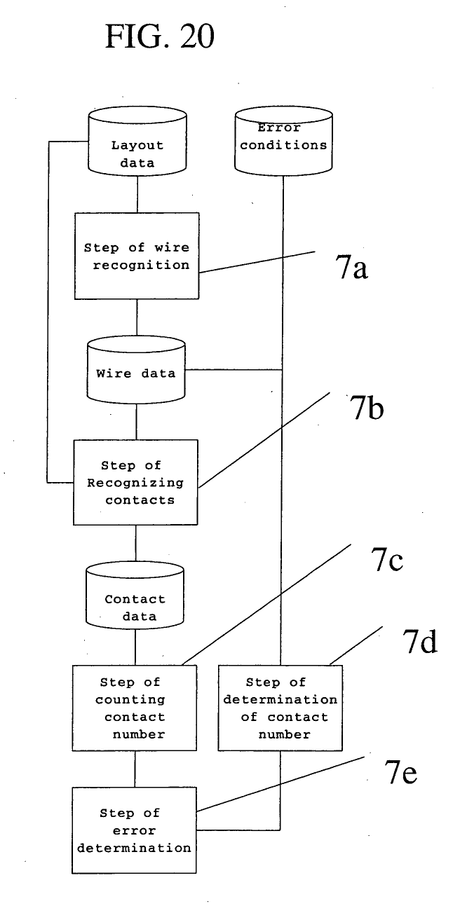

The seventh embodiment of this invention is described below in reference to FIGS. 20, 21, 22A, 22B, 22C, 22D and 22E.

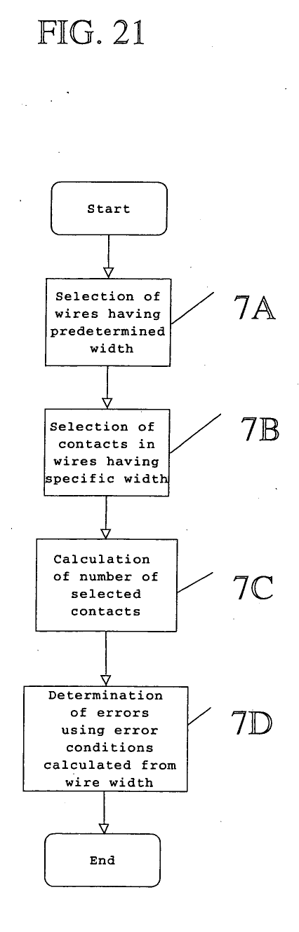

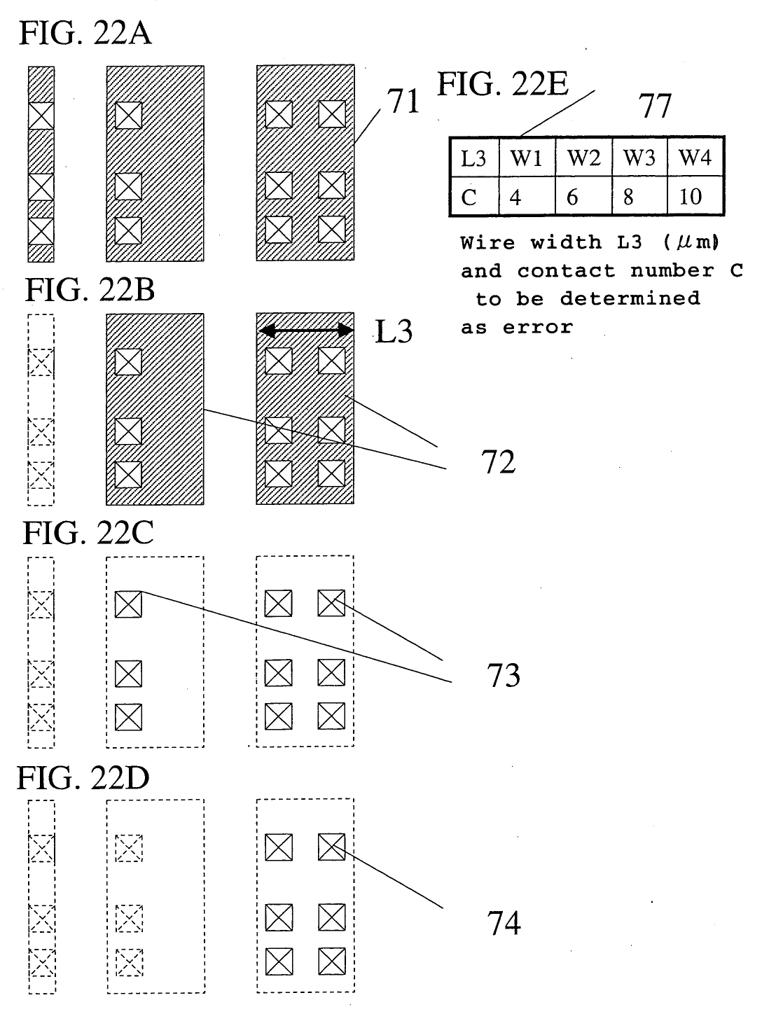

FIG. 21 is a flowchart showing the inspection algorithm according to the seventh embodiment of this invention and FIGS. 22A, 22B, 22C, 22D and 22E are diagrams showing the inspection process according to the seventh embodiment of this invention. In the following, the inspection procedure is described according to the flowchart.

This semiconductor device layout inspection method is a method for inspecting formation defects that will occur in wires of a large area in a chip layout, which includes: the step of calculating the number of contact holes in wires of a constant width; and the step of determining the number limitation value of the contact holes in accordance with the wire width, wherein the area is detected as a wire formation defect when the number of contact holes is equal to, or greater than, the number limitation value.

In this case, as shown in FIGS. 22A and 22B, a wire 72 having a width greater than wire width L3, which is considered to have a high possibility of wire formation defects in layout 71 is selected in advance (Step 7A). Contact holes 73 that overlap wire 72 selected in step 7A are selected (Step 7B). The number of contact holes selected in step 7B is calculated (Step 7C). The number limitation value of contact holes 73 calculated in step 7C is uniquely determined by the contact number limitation value C (for example, range of L3=W→4 or more) depending on the range of wire width L3 in table 77 of FIG. 22E. As shown in FIGS. 22C and 22D, the determined limitation number 4 and the number of contact holes 74 that has been calculated in step 7C are compared and the area is detected as an error portion wherein a wire formation defect may occur in the case wherein the number is equal to, or greater than, the limitation number (4) (Step 7D).

FIG. 20 is a dataflow diagram showing a flow of data at the time of inspection according to the seventh embodiment of this invention. In the following the dataflow is described.

As shown in FIG. 20, in wire recognition step 7a, wire width L3 that is considered to have a high possibility of a wire formation defect is defined in advance and wire data 72 having widths equal to, or greater than, wire width L3 is selected from inputted layout data 71 so as to be outputted. Wire data 72 that has been outputted in wire recognition step 7a and input layout data 71 are inputted in contact recognition step 7b so that contact hole data 73 that overlaps wire data 72 is selected from input layout data 71 so as to be outputted. Contact hole data 73 outputted in contact recognition step 7b is inputted in contact number counting step 7c so that the number is calculated and outputted. Error condition table 77 that has been prescribed in advance by the occurrence ratio of wire defects and wire width L3 (um) outputted in wire recognition step 7a are inputted in contact number determination step 7d so that the contact number limitation value C depending on wire width L3 (μm) is determined and outputted.

The limitation value (for example, W1=4, or greater) of the contact number outputted in contact number determination step 7d and the number of contact hole data 73 calculated in contact number counting step 7c are inputted and are compared in error determination step 7e so that contact hole data 74 selected is outputted as errors in the case of 4 or greater.

According to the above described procedure, portions wherein wire formation defects may occur in the input layout can be detected.

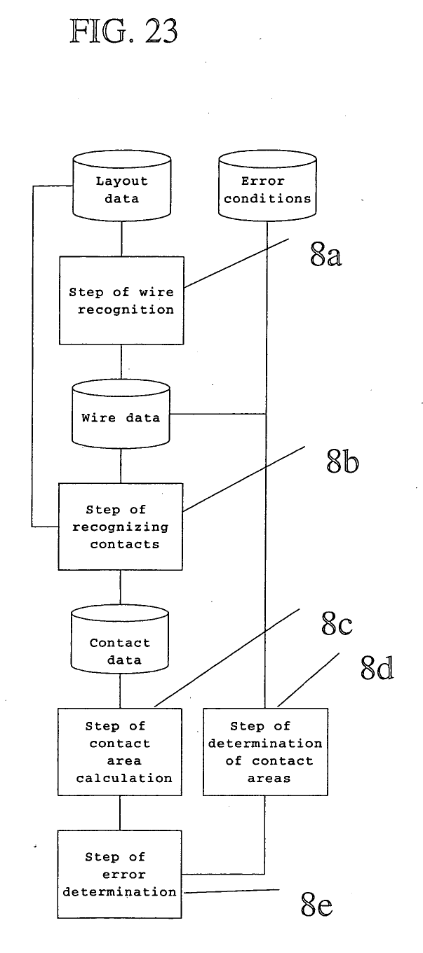

The eighth embodiment of this invention is described below in reference to FIGS. 23, 24, 25A, 25B, 25C, 25D and 25E.

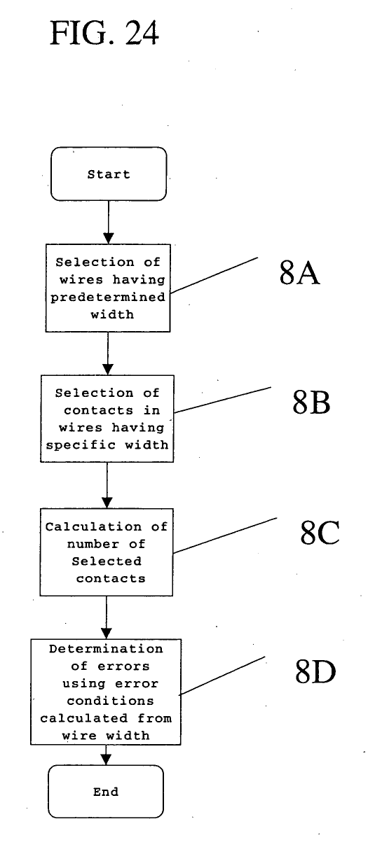

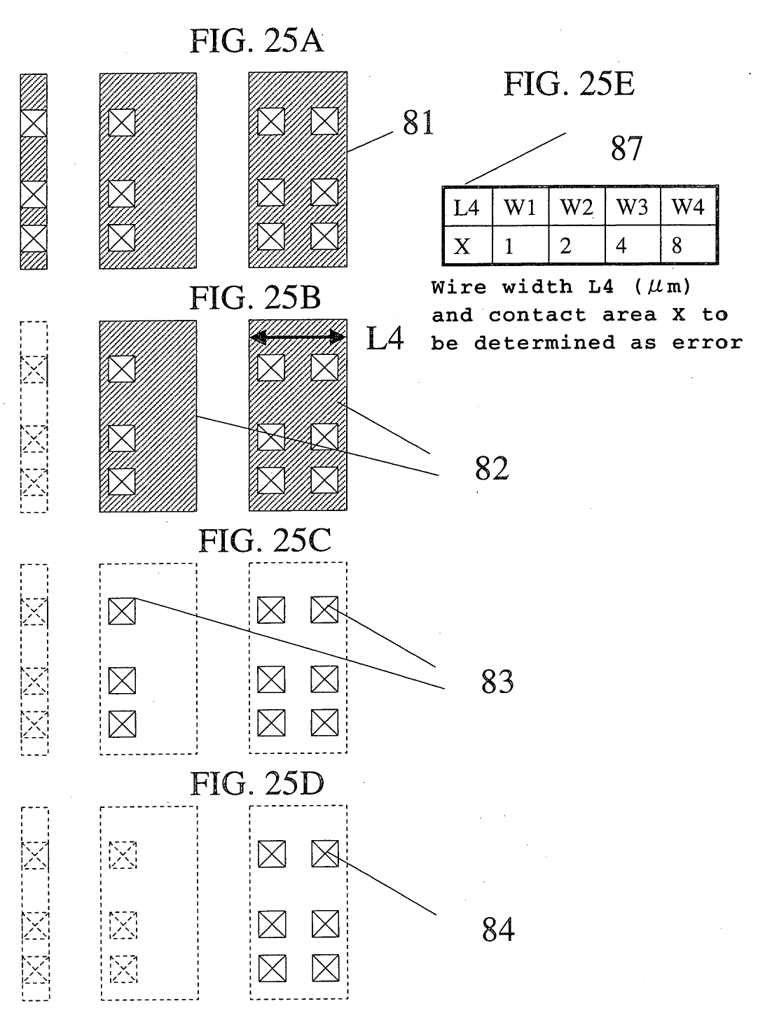

FIG. 24 is a flowchart showing an inspection algorithm according to the eighth embodiment of this invention and FIGS. 25A, 25B, 25C, 25D and 25E are diagrams showing an inspection process according to the eighth embodiment of this invention. In the following, the inspection procedure is described according to the flowchart.

This semiconductor device layout inspection method is a method for inspecting formation defects that will occur in wires of a large area in a chip layout, which includes: the step of calculating the total area of the contact holes in a wire of a constant width; and the step of determining the area limitation value of the contact holes in accordance with the wire width, wherein the area is detected as a wire formation defect when the total area of the contact holes is equal to, or greater than, the area limitation value.

In this case, as shown in FIGS. 25A and 25B, a wire 82 having a width equal to, or greater than wire width L4, which is considered to have a high possibility of a wire formation defect is in advance selected in layout 81 (Step 8A). Contact holes 83 that overlap wire 82 selected in step 8A is selected (Step 8B). The total area of the contact holes selected in step 8B is calculated (Step 8C). The area limitation value of the contact holes calculated in step 8C is uniquely determined by the contact area limitation value X (for example, range of W1→area of 1 μm², or greater) that depends on the range of wire width L4 in table 87 of FIG. 25E. As shown in FIGS. 25C and 25D, the determined limitation area X (μm²) and the area of contact holes 84 calculated in step 8C are compared so that the area is detected as an error portion where a wire formation defect may occur in the case wherein the area becomes X (μm²) or greater (Step 8D).

FIG. 23 is a dataflow diagram showing a flow of data at the time of inspection according to the eighth embodiment of this invention. In the following the dataflow is described.

As shown in FIG. 23, wire data 82 of wires of which the width is wire width L4 or greater wherein the possibility of wire formation defects is considered to be had is in advance selected and outputted from layout data 81 in the wire recognition step 8a. Wire data 82 outputted in wire recognition step 8a and input layout data 81 are inputted in contact recognition step 8b and contact hole data 83 that overlaps wire data 82 is selected and outputted from input layout data 81. Contact hole data 83 outputted in contact recognition step 8b is inputted in contact area calculation step 8c so that the total area of contact hole data 83 is calculated and outputted. Error condition table 87 prescribed from the occurrence ratio of wire defects and wire width L4 (μm) outputted in wire recognition step 8a are in advance inputted in contact area determination step 8d so that the total contact hole area X (μm²) depending on wire width L4 (μm) is uniquely determined and is outputted.

The limitation value (for example, W1=1 μm² or greater) of the total contact area that have been outputted in contact area determination step 8d and the total contact hole area that have been calculated in contact area calculation step 8c are inputted and compared so that contact hole data 84 that has been selected as errors in the case wherein the area is 1 μm² or greater is outputted.

According to the above described procedure, the portions where wire formation defects occur can be detected in the input layout.

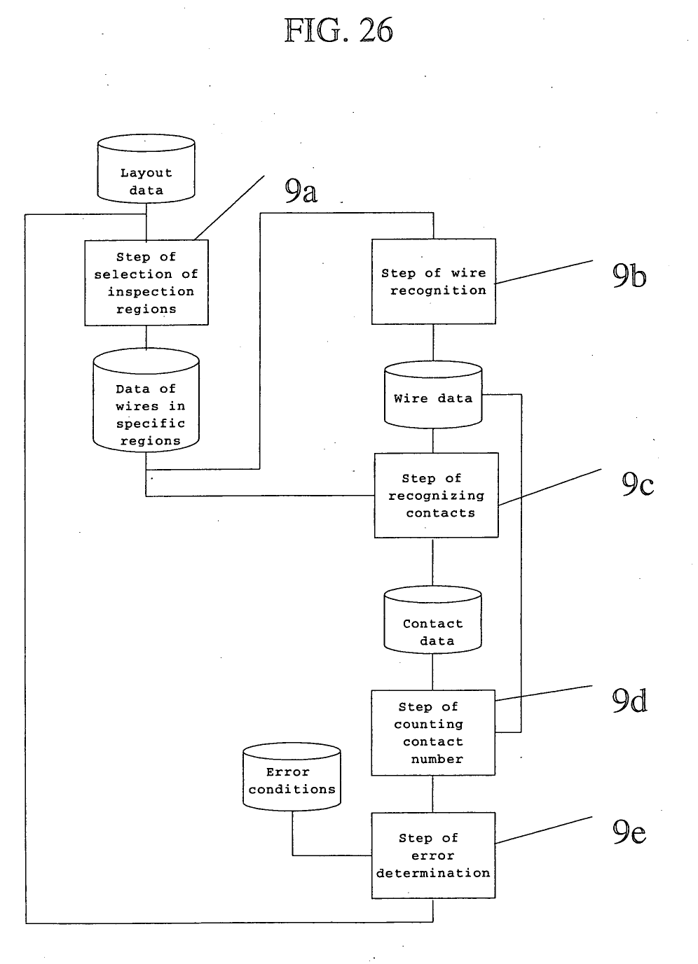

The ninth embodiment of this invention is described below in reference to FIGS. 26, 27, 28A, 28B, 28C, 28D, 29A, 29B, 29C, 29D, 29E, 30A, 30B, 30C, 30D, 30E and 30F.

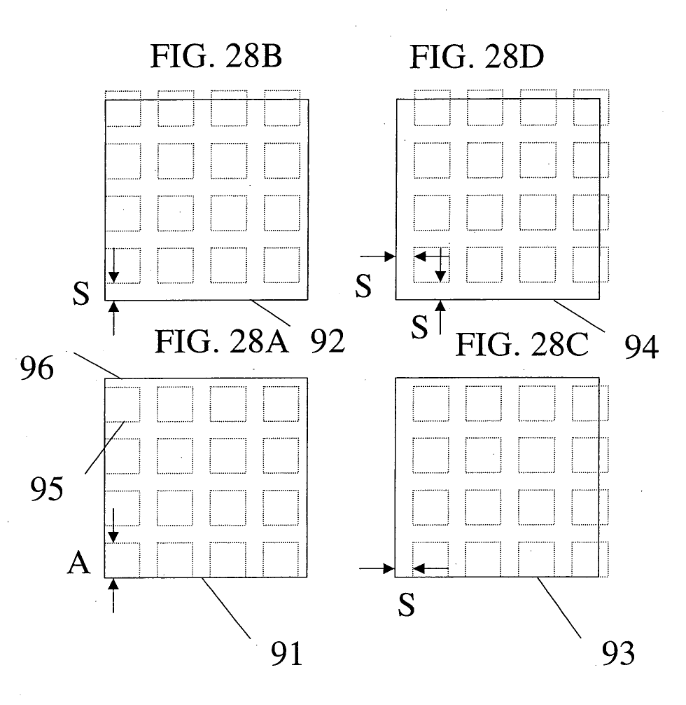

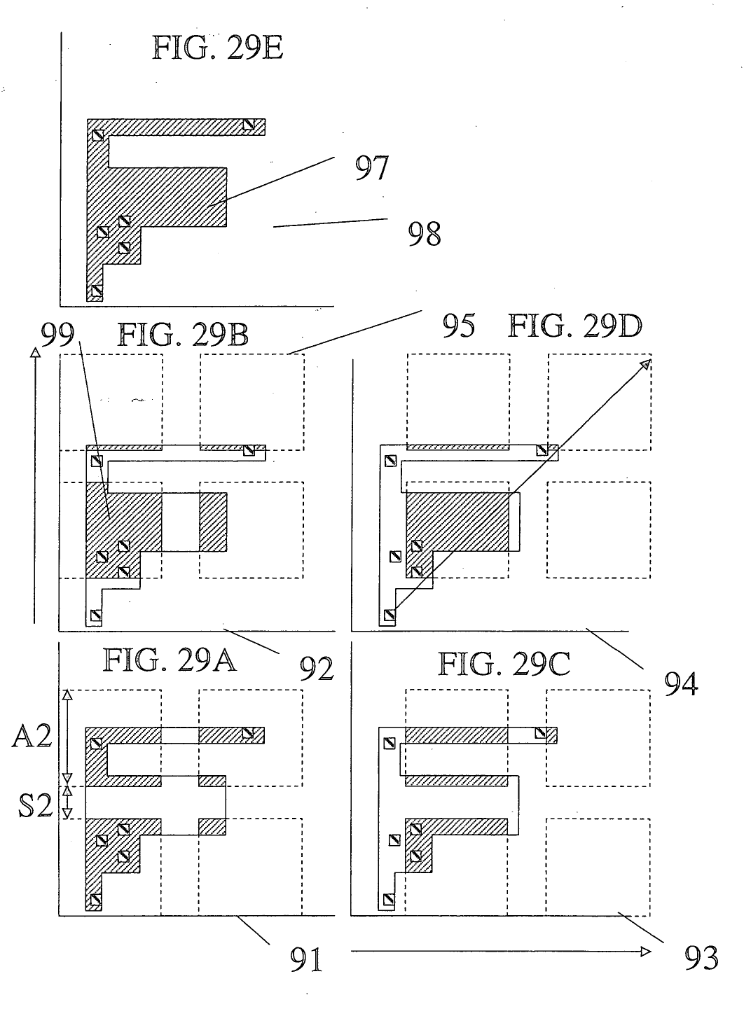

FIGS. 28A, 28B, 28C and 28D are diagrams showing a region wherein the number of contact holes is collectively inspected according to the ninth embodiment of this invention. Region 96 shown by solid lines indicates the entire surface of the chip to be inspected. Regions 95 shown by dotted lines, respectively, have four sides with a predetermined inspection region width A and indicate inspection regions aligned in the longitudinal direction and in the lateral direction with equal intervals S. Symbols 91 to 94 indicate the shift conditions of the inspection regions. FIGS. 29A, 29B, 29C, 29D and 29E show enlarged inspection regions of FIGS. 28A, 28B, 28C and 28D relative to wire layout 98.

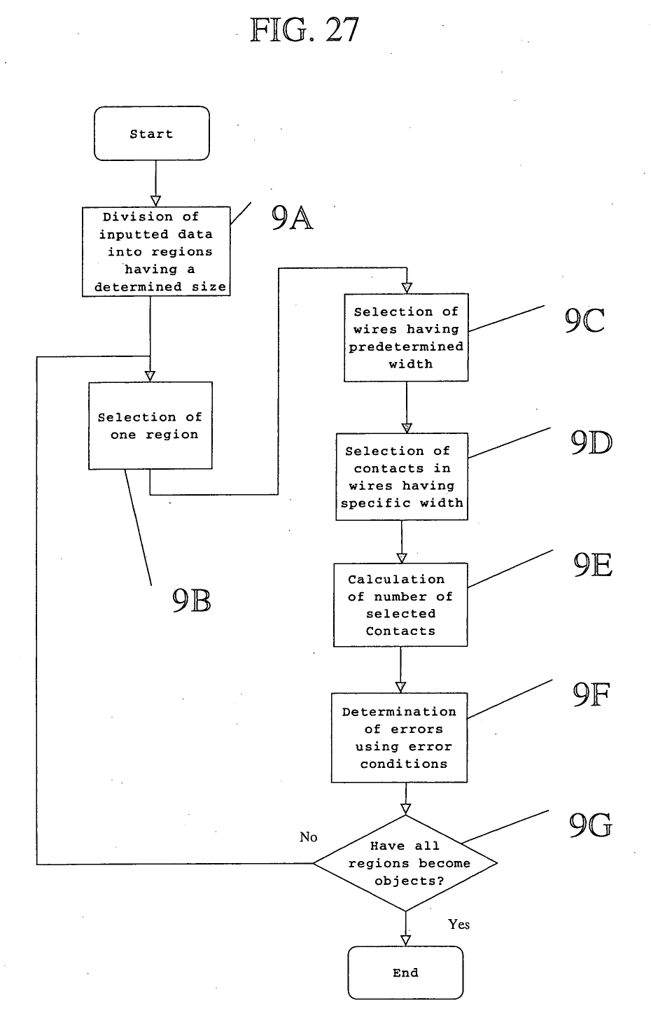

FIG. 27 is a flowchart showing an inspection algorithm according to the ninth embodiment of this invention. In the following the inspection procedure is described according to the flowchart.

This semiconductor device layout inspection method is a method for inspecting formation defects that will occur in wires of a large area in a chip layout, including the step of dividing the entire surface of the chip layout into a plurality of inspection regions; the step of limiting the number of contact holes in a wire of a constant width in the inspection regions; the step of inspecting wire formation defects by determining whether or not the area has a defect based on this number limitation; and the step of allowing the inspection regions to scan the entire surface of the chip layout.

In this case, as shown in FIGS. 29A, 29B, 29C, 29D and 29E, the total inspection region 95 is defined in input layout 98, which is the inspection object. The inspection regions, respectively, have four sides with width A which are aligned in the longitudinal direction and in the lateral direction with equal intervals S (Step 9A). In the following, the method for limiting the contact hole number utilizing the inspection regions is described.

An inspection is carried out in inspection region 95 and when this inspection is completed inspection region 95 shifts within the layout to be inspected and an inspection of another region is again carried out. Inspection region 95 scans the entire surface and the inspection of the entire surface of the layout is completed. In the following one example where inspection region 95 shifts is cited and described.

First, an inspection region is selected so as to be placed in the lower left of the entire surface of the layout (condition indicated by symbol 91 of FIG. 29A). When the inspection is completed in region 95, inspection region 95 is then shifted by an interval that has in advance been determined by the data scale to be processed in the longitudinal direction 92 (FIG. 29B) The amount of shift of inspection region 95 and the size of one frame of inspection region 95 are varied depending on the data scale to be processed such that whether the entire inspection region is the entire surface of the chip or one block of the chip and, thereby, the inspection of the entire surface of the chip can be utilized in accordance with the purpose such that the process TAT is prioritized or a detailed inspection for a portion of the chip is prioritized. Such a shift in the longitudinal direction as indicated by symbol 92 is repeated until the inspection region has been shifted by S (interval of inspection region)+A (length of one side of the frame of the inspection region) from the initial position. Next, shifting is repeated until the inspection region has been shifted by S+A in the lateral direction as indicated by symbol 93 in the same manner as the above (FIG. 29C). Finally, shifting is repeated until the inspection region has been shifted in the diagonal direction indicated by symbol 94 in the same manner as the above (FIG. 29D). The inspection of the entire surface of the layout is completed at the point of time when shifting is completed in the three directions (Step 9B).

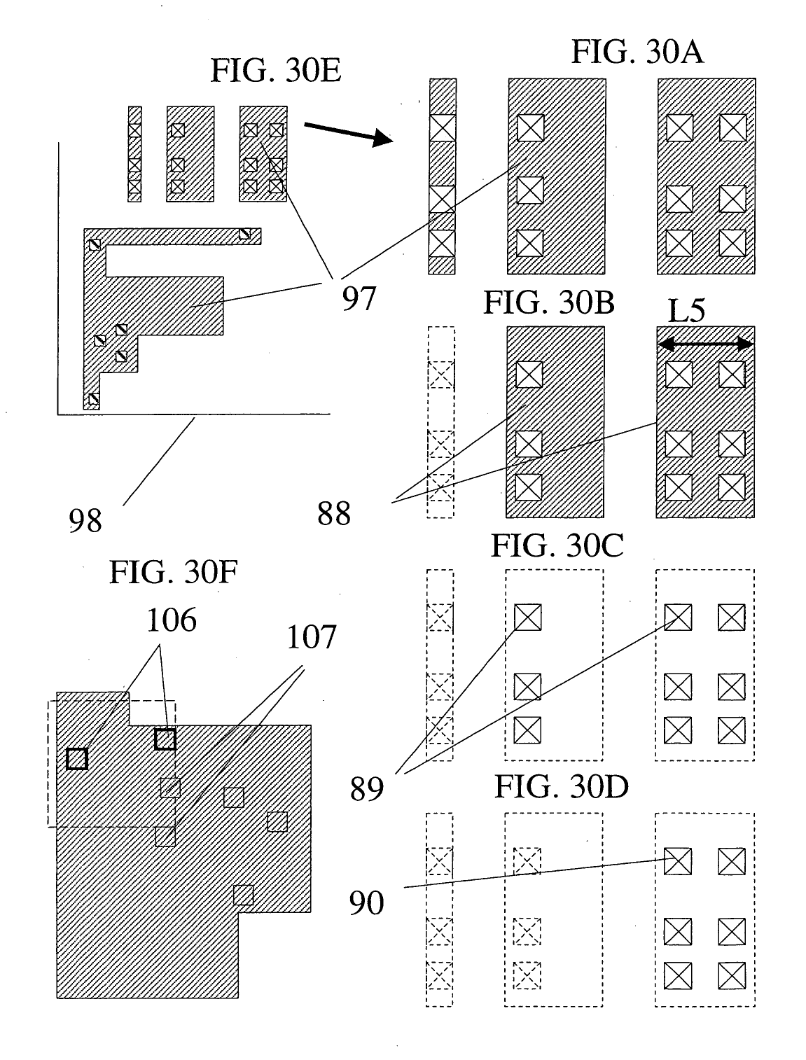

Next, a region 99 is selected wherein inspection region 95 and wire 97 within layout 98 overlap. As shown in FIGS. 30A and 30B, wire region 88 having wire width L5 which is considered to have a high possibility of wire formation defects is in advance selected from among the wire regions resulting from step 9C (Step 9C). As shown in FIG. 30C, a contact hole 89 that overlaps the wire selected in step 9C is selected (Step 9D). In the case wherein the contact hole selected at this time crosses inspection region 95 or in the case wherein the contact hole makes contact with the outside, the contact hole (symbol 107 shown in FIG. 30F) is not counted. The contact holes become count objects only in the case wherein the entirety thereof is included in inspection region 95 (symbol 106 shown in FIG. 30F). The number of selected contact holes 89 is calculated (Step 9E). As shown in FIG. 30D, the area is detected as an error portion 90 where wire formation defects will occur in the case wherein the number of contact holes 89 calculated in step 9E is compared with the predetermined error conditions so that the number of contact holes is equal to be the limitation value, or greater (Step 9F). Next, it is determined whether or not inspection region 95 has scanned the entire surface of the chip (Step 9G). In the case wherein the inspection region has not scanned the entirety of the chip steps 9B to 9G are repeated. In the case wherein the inspection region has scanned the entirety of the chip, the inspection is completed.

FIG. 26 is a dataflow diagram showing a flow of data at the time of inspection according to the ninth embodiment of this invention. In the following the dataflow is described.

As shown in FIG. 26, layout data 98 is inputted in inspection region selection step 9a and correction inspection region data 95 in the layout to be inspected is defined so that wires that overlap layout data 98 are selected and outputted as specific region wire data 97. In wire recognition step 9b, wire data 88 having predetermined width L5 is selected and outputted specific region wire data 97 outputted in inspection region selection step 9a. Specific region wire data 97 outputted in inspection region selection step 9a and wire data 88 outputted in wire recognition step 9b are inputted in contact recognition step 9c and contact hole data 89 that overlaps wire data 88 is selected and is outputted from specific region wire data 97.

Contact hole data 89 outputted in contact recognition step 9c is inputted in contact number counting step 9d so that the number of contact holes is calculated. The number of contact holes outputted in contact number counting step 9d and predetermined error conditions are compared in error determination step 9e so as to output as an error contact hole data 90 selected in the case wherein the conditions are not satisfied.

According to the above described procedure, the portions wherein wire formation defects occur can be detected in the input layout.

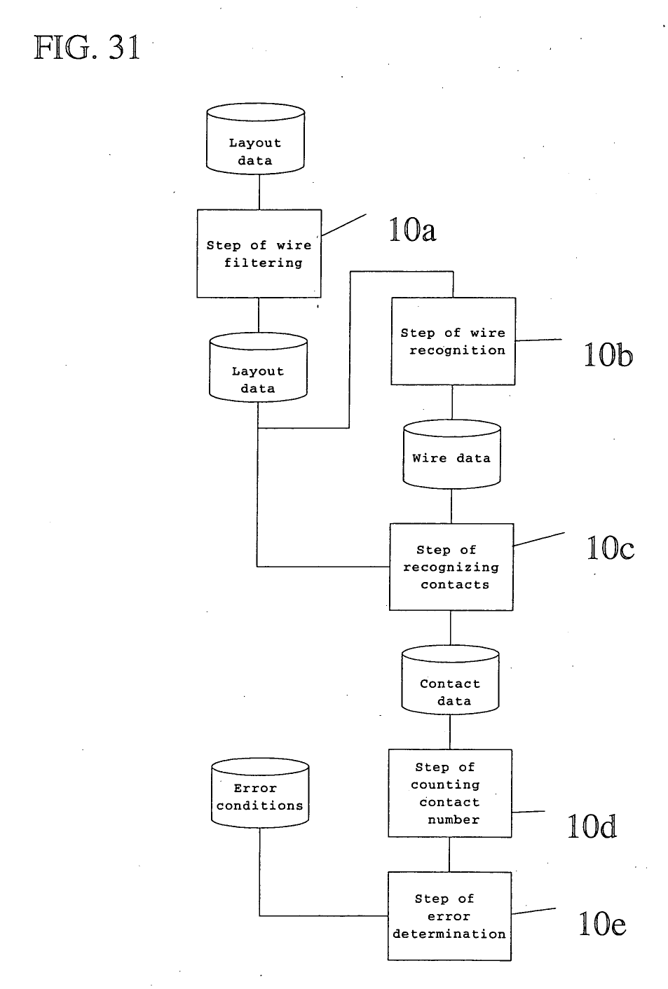

The tenth embodiment of this invention is described below in reference to FIGS. 31, 32, 33A, 33B, 33C, 33D and 33E.

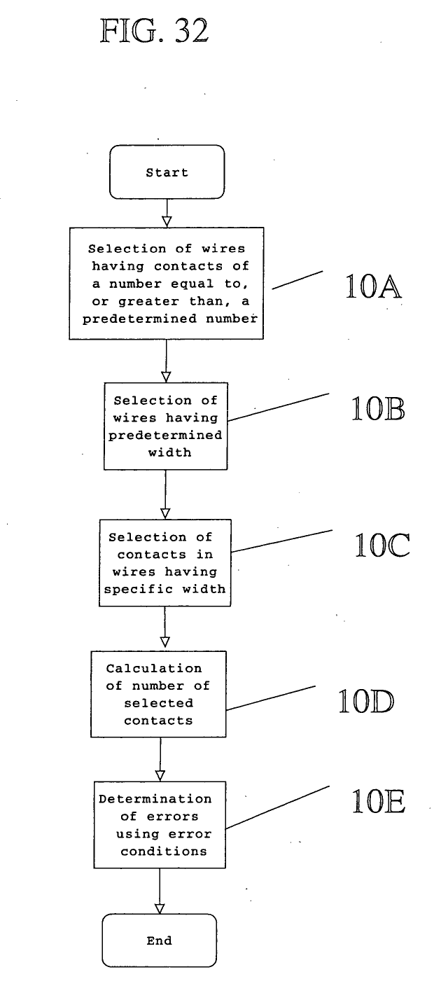

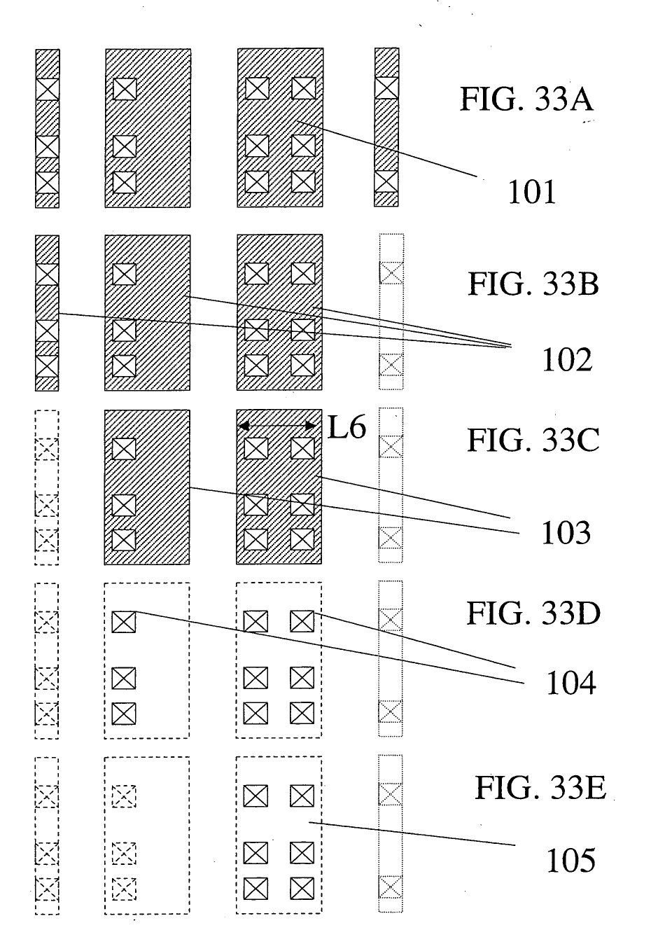

FIG. 32 is a flowchart showing an inspection algorithm of the tenth embodiment of this invention and FIGS. 33A, 33B, 33C, 33D and 33E are diagrams showing the inspection process according to the tenth embodiment of this invention. In the following the inspection procedure is described according to the flowchart.

According to this semiconductor device layout inspection method, the number of the contact holes in wires of a constant width is limited after wires of which the number of contact holes connected thereto is less than a constant number has in advance been removed from the chip layout in the third embodiment.

In this case the minimum number (for example, three) of contact holes in a wire is defined as having a high possibility of defect occurrence. Next, as shown in FIGS. 33A and 33B, wires 102 having contact holes of which the number is equal to, or greater than, that defined in input layout 101 are selected and, thereby, wires which is not required to be inspected are deleted so as to shorten the CAD process TAT (Step 10A). As shown in FIG. 33C, wires 103 having widths which are equal to, or greater than, predetermined wire width L6 are solely selected from layout 102 that has been filtered in step 10A (Step 10B). As shown in FIG. 33D, contact holes 104 that overlap wires 103 selected from layout 102 that has been filtered are selected (Step 10C). As shown in FIG. 33E, the number of the selected contact holes is calculated (Step 10D) and the predetermined error conditions and the number of contact holes that has been calculated in step 10D are compared so that (three or more) contact holes 105 which do not satisfy the conditions are outputted (Step 10E).

FIG. 31 is a dataflow diagram showing a flow of data at the time of inspection according to the tenth embodiment of this invention. In the following the dataflow is described.

As shown in FIG. 31, layout data 101 is inputted in wire filtering step 10a and layout data 102 is outputted wherein the wires having no possibility of occurrence of wire formation defects are deleted due to the number of contact holes. Wire width L6 that is considered to have a high possibility of wire formation defects is in advance defined in wire recognition step 10b and wire data 103 of wires having a width equal to, or greater than, wire width L6 is selected and outputted from inputted layout data 102. Wire data 103 outputted in wire recognition step 10b and layout data 102 are inputted in contact recognition step 10c and contact hole data 104 that overlaps wire data 103 is selected and outputted from layout data 102.

Contact hole data 104 outputted in contact recognition step 10c is inputted in contact number counting step 10d so that the number is calculated and outputted. The number of the contact holes of contact hole data 104 outputted in contact number counting step 10d is inputted in error determination step 10e and contact hole data 105 is outputted that becomes an error corresponding to the number limitation (for example, four or greater) that has been set depending on wire width L6.

According to the above described procedure, the portions where wire formation defects may occur can be detected in the input layout.

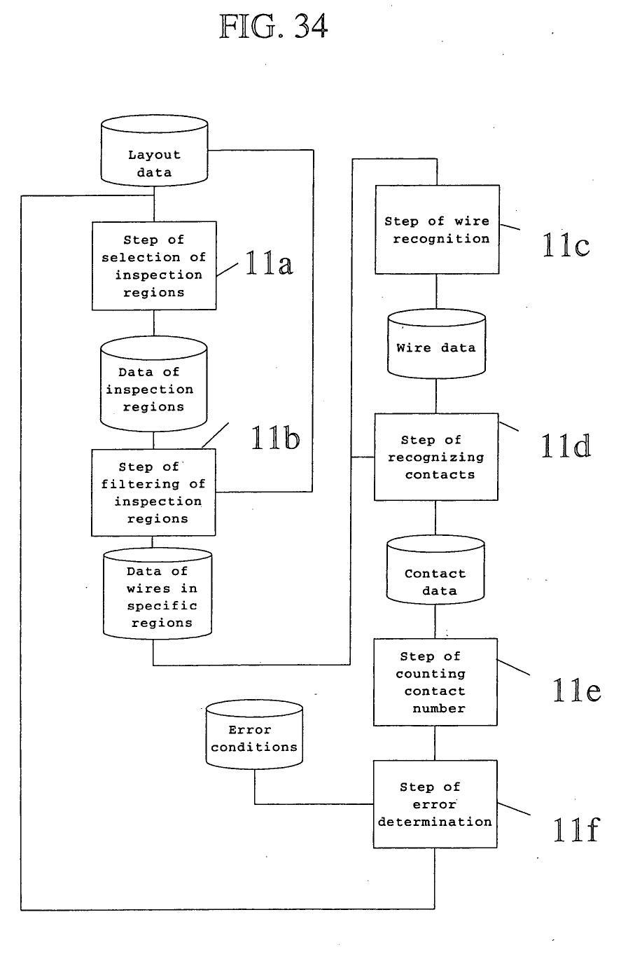

The eleventh embodiment of this invention is described in reference to FIGS. 34, 35, 36A, 36B, 36C, 36D, 37A, 37B, 37C, 37D, 37E, 38A, 38B, 38C, 38D, 39A, 39B, 39C, 39D and 39E.

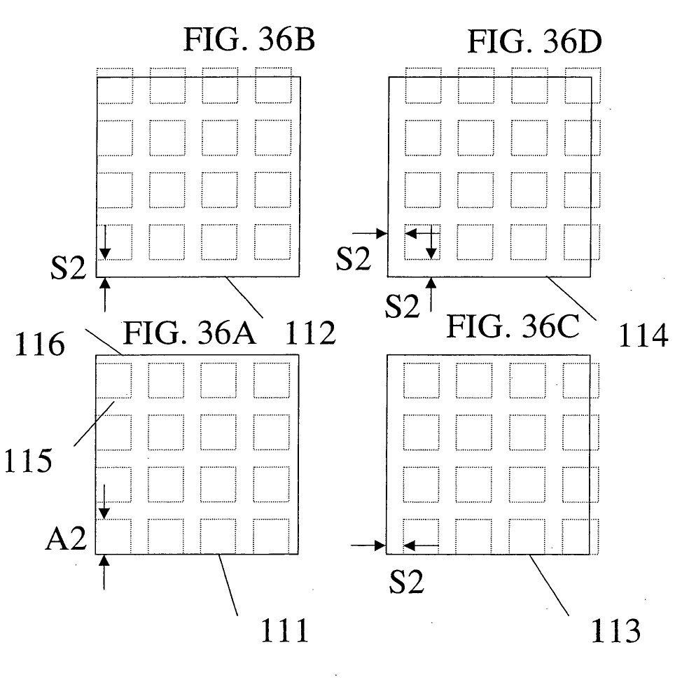

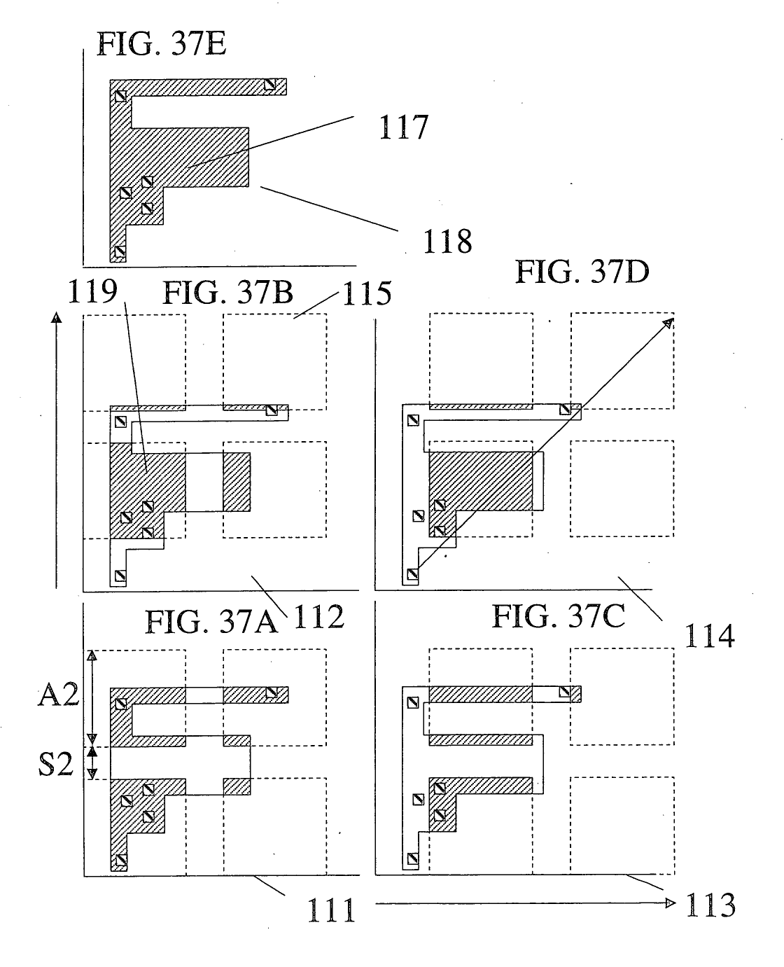

FIGS. 36A, 36B, 36C and 36D are diagrams showing a region wherein the number of contact holes is collectively inspected according to the eleventh embodiment of this invention. A region 116 indicated by solid lines represents the entire surface of the chip to be inspected. Regions 115 indicated by dotted lines respectively have four sides of a predetermined inspection region width A2 and represent the inspection regions aligned in the longitudinal direction and in the lateral direction with equal intervals S2. Symbols 111 to 114 show the shift conditions of the inspection region. FIGS. 37A, 37B, 37C, 37D and 37E show enlarged inspection regions of FIGS. 36A, 36B, 36C and 36D relative to wire layout 118.

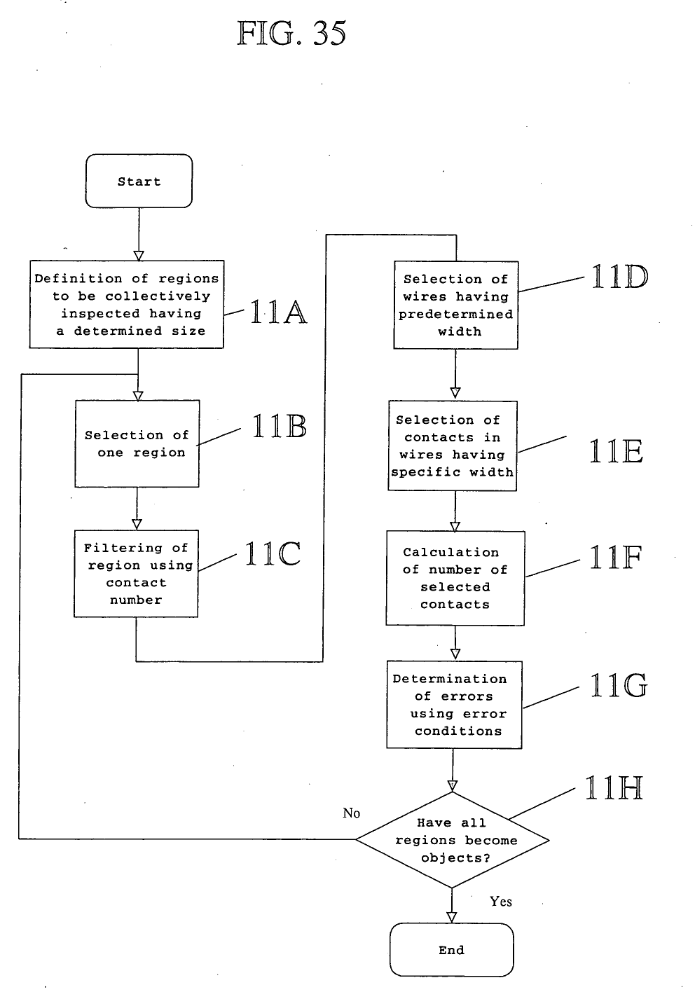

FIG. 35 is a flowchart showing an inspection algorithm according to the eleventh embodiment of this invention. In the following the inspection procedure is described according to the flowchart.

According to this semiconductor device layout inspection method, the inspection regions are limited to the inspection regions having contact holes of which the number is equal to, or greater than, a constant number from among a plurality of inspection regions and the number of contact holes is limited in wires having a constant width in the ninth embodiment.

In this case, as shown in FIGS. 37A, 37B, 37C, 37D and 37E, total inspection region 115 is defined in input layout 118, which is an inspection object. The inspection regions respectively have four sides of width A2 and are aligned in the longitudinal direction and in the lateral direction with equal intervals S2 (Step 11A). In the following the contact hole limitation method using the inspection regions is described.

An inspection is carried out in inspection region 115 and when the inspection is completed inspection region 115 is shifted within the layout to be inspected so that another region is inspected. When inspection region 115 scanned the entire surface the inspection of the entire surface of the layout is completed. In the following an example wherein inspection region 115 shifts is cited and explained.

First, an inspection region is selected so that the region lines up with the lower left of the entire surface of the layout (condition of symbol 111 in FIG. 37A). When the inspection of inspection of section 115 integrated circuit completed, inspection region 115 is then shifted by a predetermined interval in the longitudinal direction 112 (FIG. 37B). The amount of shift inspection region 115 and the size of one frame of inspection region 115 are varied according to the data scale to be processed such that whether the entire inspection region is the entire surface of the chip or one block and thereby, an inspection can be used according to a purpose such that the inspection of the entire surface of the chip is carried out by prioritizing the process TAT and an inspection for a portion of the chip carried out by prioritizing the detail of the inspection. The shift in the longitudinal direction indicated by symbol 112 is repeated until the region is shifted by S2 (interval between inspection regions)+A2 (length of one side of the frame of an inspection region) from the original position. Next, the shift is repeated in the lateral direction as indicated by symbol 113 in the same manner, as the above until the inspection region is shifted by S2+A2 (FIG. 37C). Finally, the shift is repeated in a diagonally direction as indicated by symbol 114 in the same manner as the above until the inspection region is shifted (FIG. 37D). The inspection of the entire surface of the layout is completed at the point in time when the shifts in the three directions are completed (Step 11B).

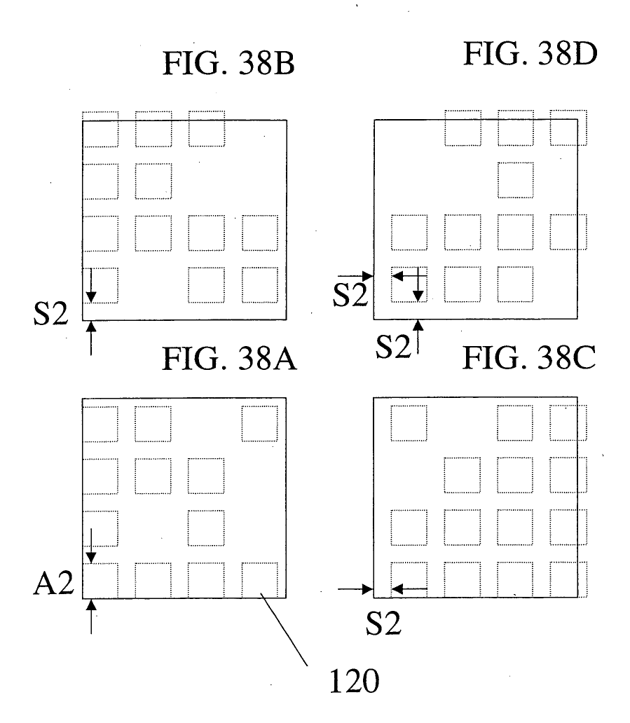

Region 115 selected in step 11B is filtered using the number of contact holes. It is not necessary to inspect the regions having two or less contact holes in the case wherein a wire formation defect occurs when the number of contact holes is at least three irrelevant of the area and the width of the wires and therefore, an inspection region 120 wherein three or more contact holes exist is selected from inspection region 115 that has been selected in step 11B as shown in FIGS. 38A, 38B, 38C and 38D (Step 11C) and thereby the inspection process TAT can be shortened.

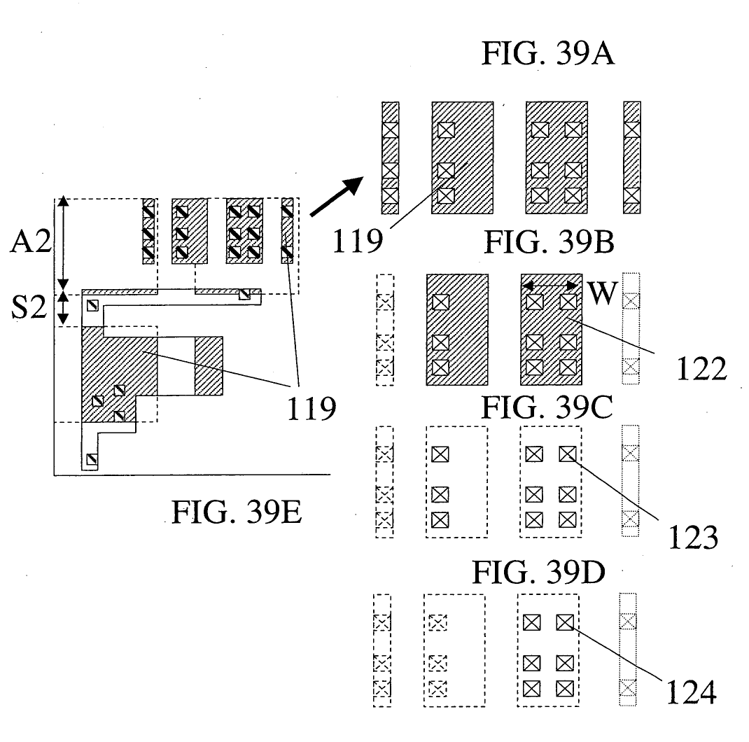

Next a region 119 wherein the filtered inspection region 120 and wire 117 within layout 118 overlap is selected (Step 11C). As shown in FIGS. 39A and 39B, a wire region 122 having a width that is equal to or greater than a predetermined width W is selected from among the wire region resulting from step 11C (Step 1D). As shown in FIG. 39C, a contact hole 123 that overlaps the wire selected in step 11D is selected (Step 1E). The number of the selected contacted holes 123 is calculated (Step 11F). The number of contact holes 123 that has been calculated in step 11F is compared with predetermined error conditions and the area is detected as an error portion where a wire formation defect may occur in the case wherein the number is equal to or greater than the limitation value (symbol 124 of FIG. 39D) (Step 11G). Next, it is determined whether or not inspection region 115 has scanned the entire surface of the chip (Step 11H). Steps 11B to 11G are repeated in the case wherein the entirety has not been scanned. The inspection is completed in the case wherein the entirety has been scanned.

FIG. 34 is a dataflow diagram showing a flow of data at the time of inspection according to the eleventh embodiment of this invention. In the following, the dataflow is described.

As show in FIG. 34, layout data 118 is inputted in inspection region selecting step 11a and total inspection region data 115 is selected and outputted. Inspection region data 115 and layout data 118 are inputted in inspection region filtering step 11b and a portion wherein inspection region 120 having three or more contact holes and wire 117 overlap is outputted as specific region wire data 119 from inspection region data 115. Wire data 122 of wires having a predetermined width W is selected and outputted from specific region wire data 119 that is outputted from inspection region filtering step 11b in wire recognition step 11c. Specific region wire data 119 outputted in inspection region filtering step 11b and wire data 122 outputted in wire recognition step 11c are inputted in contact recognition step 11d and contact hole data 123 that overlaps specific inspection wire data 119 is selected and outputted from specific inspection wire data 119.

Contact hole data 123 outputted in contact recognition step 11d is inputted in contact number counting step 11e so that the number of contact holes is calculated. The number of contact holes outputted in contact number counting step 11e is compared with predetermined error conditions in error determination step 11f so that contact hole data 124 selected is outputted as an error in the case wherein the conditions are not satisfied.

According to the above described procedure, portions where wire formation defects will occur can be detected in the input layout.

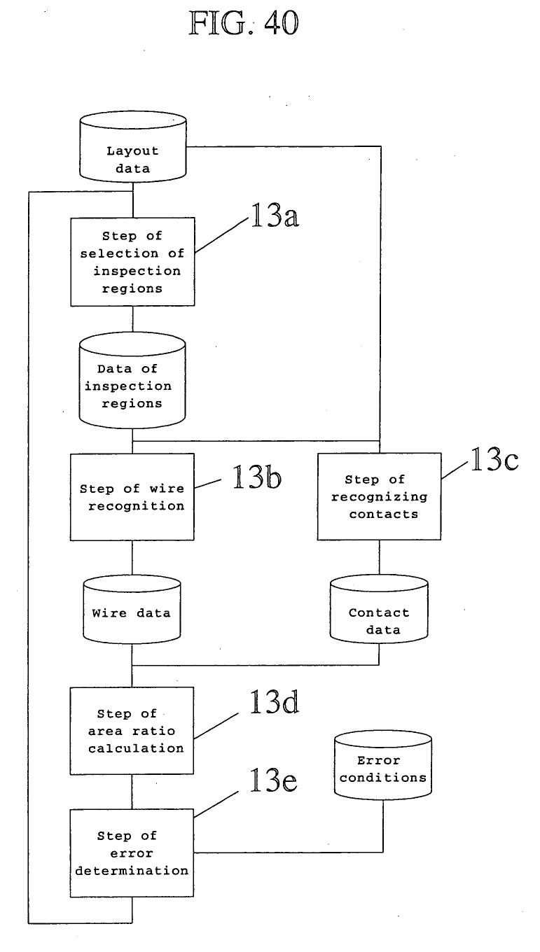

The twelfth embodiment of this invention is described below in reference to FIGS. 40, 41, 42A, 42B, 42C, 42D, 43A, 43B, 43C and 43D.

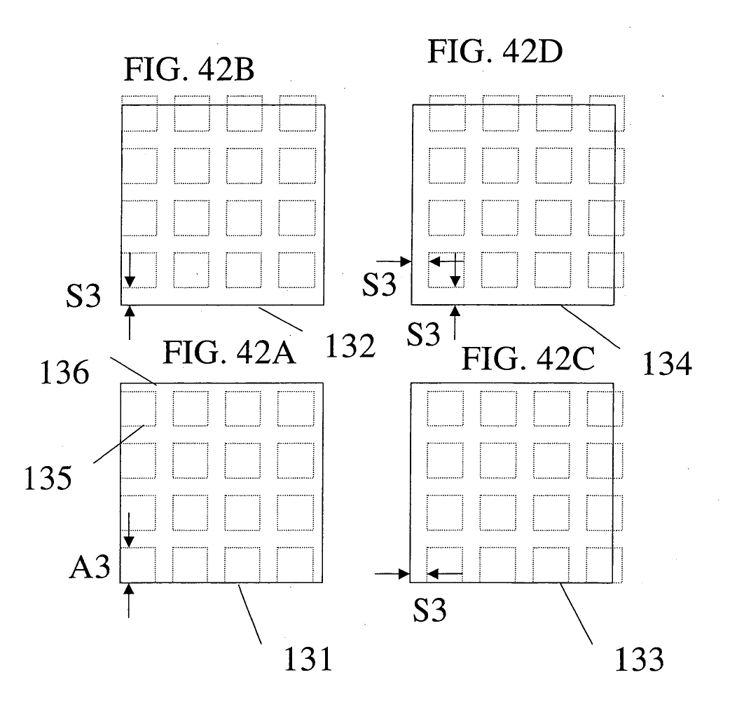

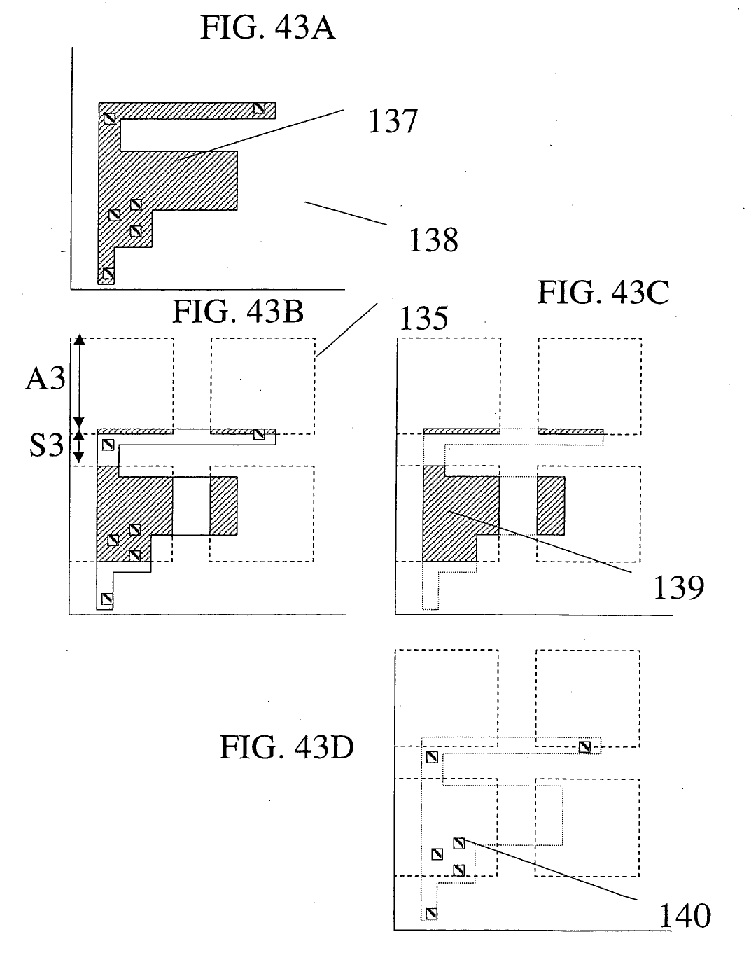

FIGS. 42A, 42B, 42C, and 42D are diagrams showing an area where the number of contact holes is collectively inspected according to the twelfth embodiment of this invention. Region 136 indicated by solid lines represents the entire surface of the chip to be inspected. Regions 135 indicated by dotted lines have four sides respectively of a predetermined inspection region width A3 and represent inspection regions aligned in the longitudinal direction and the lateral direction with equal intervals S3. Symbols 131 to 134 show the shift conditions of the inspection regions. FIGS. 43A, 43B, 43C and 43D show enlarged inspection regions of FIGS. 42A, 42B, 42C and 42D relative to wire layout 138.

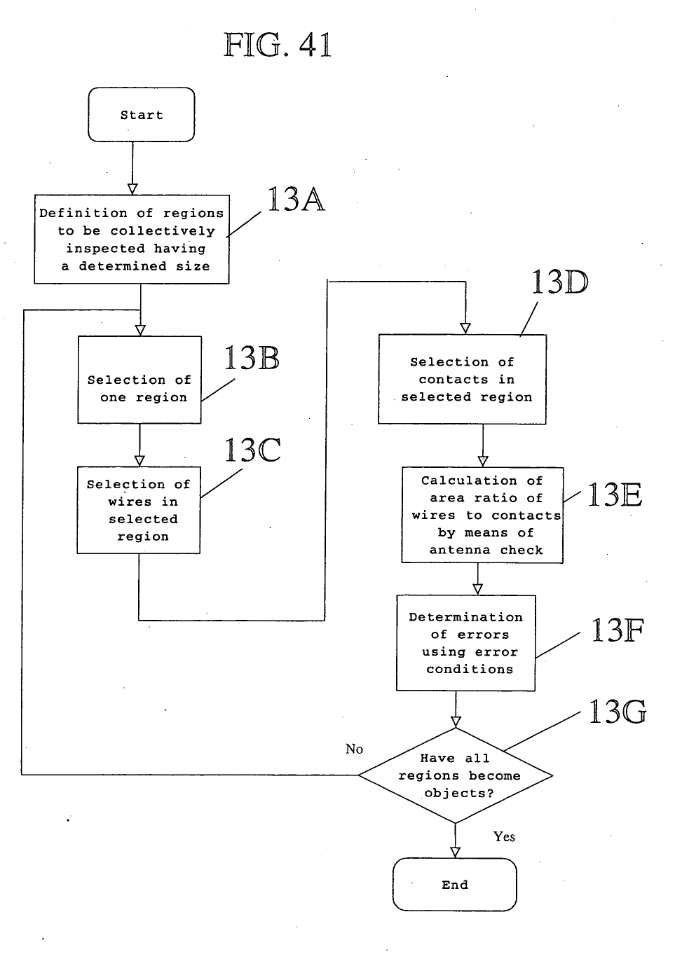

FIG. 41 is a flowchart showing an inspection algorithm according to the twelfth embodiment of this invention. In the following, the inspection procedure is described according to the flowchart.

This semiconductor device layout inspection method is a method for inspecting the occurrence of formation defects in wires of a large area in the chip layout that includes the step of dividing the entire surface of the chip layout into a plurality of inspection regions; the step of limiting the area ratio of the total area of wires of the same node to the total area of the contact holes in the wires of the same node by using an antenna check in the inspection regions and of detecting wire formation detects by determining whether or not defects exist based on this limitation; and the step of allowing the inspection region to scan the entire surface of the chip layout.

The above described antenna check is a technology of inspection by determining a threshold value based on the ratio of gates to the wires (vias, wires) in order to prevent the breakdown of a gate of a transistor due to a charge that occurs in the plasma etching step at the time of manufacturing a semiconductor device.

In this case, a shown in FIGS. 43A, 43B, 43C and 43D, total inspection region 135 is defined in input layout 138 which is an inspection object. The inspection regions have four sides of width A3 respectively and are aligned in the longitude direction and in the lateral direction with equal intervals S3 (Step 13A). In the following, the method for limiting the area ratio of the total area of the same node to the total area of the contact holes using inspection region 135 is described.

An inspection is carried out in inspection 135 and when the inspection is finished, inspection region 135 shifts within the layout to be inspected so that another inspection of a different region is carried out. When inspection region 135 scans the entire surface, the inspection of the entire surface of the layout is completed. In the following, an example wherein inspection region 135 is shifted is cited and described.

First, an inspection region is selected so that the selected region is lined up with the lower left of the entire surface of the layout (condition of symbol 131 in FIG. 42A). When an inspection is completed in an inspection region 135, inspection region 135 is then shifted by a predetermined interval in longitudinal direction 132 (FIG. 42B). The shift in the longitudinal direction indicated by symbol 132 is repeated until the region is shifted by S3 (interval of inspection regions)+A3 (length of one side of the frames of inspection regions) from the initial position. Next, the shift in the lateral direction indicated by symbol 133 is repeated in the same manner as the above until the inspection region is shifted by S3+A3 (FIG. 42C). Finally, the shift in the diagonal direction indicated by symbol 134 is repeated in the same manner as the above until the inspection region is shifted (FIG. 42D). The inspection of the entire surface of the layout is completed at the point in time when the shifts in the three directions are completed (Step 13B).

Next, a wire 139 wherein inspection region 135 and wire 137 within layout 138 overlap is selected (Step 13C). Contact hole 140 wherein inspection region 135 and a contact hole within layout 138 overlap is selected (Step 13D). Wire 139 and contact hole 140 selected in step 13C and step 13D are used for an antenna check so that the ratio of the total area of the wires of the same node to the total area of the contact holes in the wires of the same node is calculated (Step 13E). Though the ratio of the gate to the contact connected to the gate is calculated according to a conventional antenna check, it is possible to find a ratio of a wire to a contact hole connected to the wire by using wire 139 instead of the gate. The total area ratio calculated in step 13E is compared with predetermined error conditions and is equal to be the limitation value or greater the area is detected as an error portion where a wire formation defect will occur (Step 13F). Next, it is determined whether or not inspection region 135 has scanned the entire surface of the layout (Step 13G). In the case wherein the entirety has not been scanned, steps 13B to 13G are repeated. In the case wherein the entirety has been scanned the inspection has been completed.

FIG. 40 is a dataflow diagram showing a flow of data at the time of inspection according to the twelfth embodiment of this invention. In the following, the dataflow is described.

As show in FIG. 40, layout data 138 is inputted in inspection region selecting step 13a so that total inspection region data 135 is selected and outputted. Inspection region data 135 and layout data 138 are inputted in wire recognition step 13b and wire data 139 that overlaps inspection region data 135 is selected from layout data 138. Inspection region data 135 and layout data 138 are inputted in contact recognition step 13c and contact hole data 140 that overlaps inspection region 135 is selected from the layout data. Wire data 139 selected in wire recognition step 13b and contact hole data 140 selected in contact recognition step 13c are inputted in area ratio calculating step 13d so that wire data 139 is used in place of the gate and an antenna check is carried out.

The area ratio outputted in area ratio calculating step 13d is compared with predetermined error conditions in error determination step 13e and wire data 139 and contact hole data 140 selected are outputted as errors in the case wherein the conditions are not satisfied.

According to the above described procedure portions where wire formation defects may occur can be detected from the input layout.

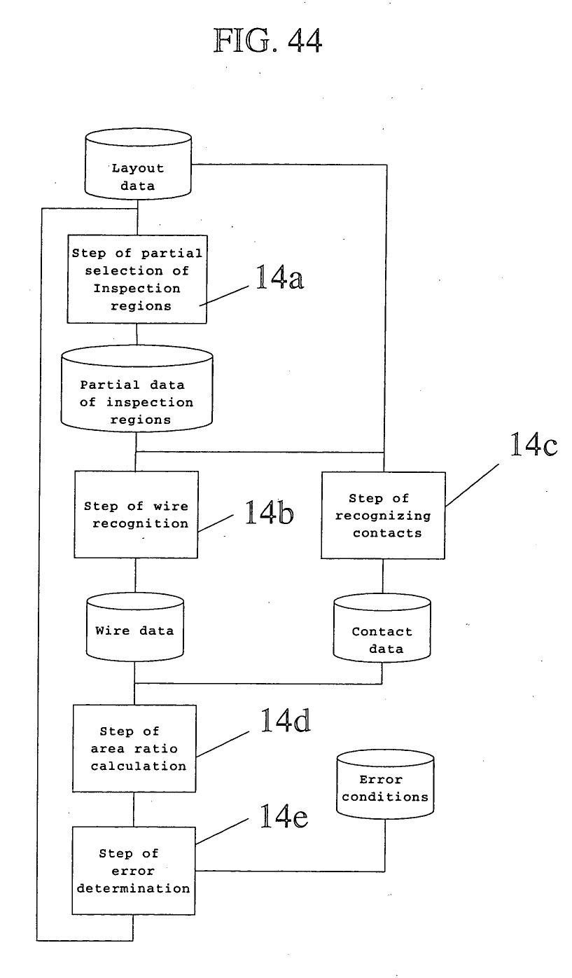

The thirteenth embodiment of this invention is described below in reference to FIGS. 44, 45, 46A, 46B, 46C and 46D.

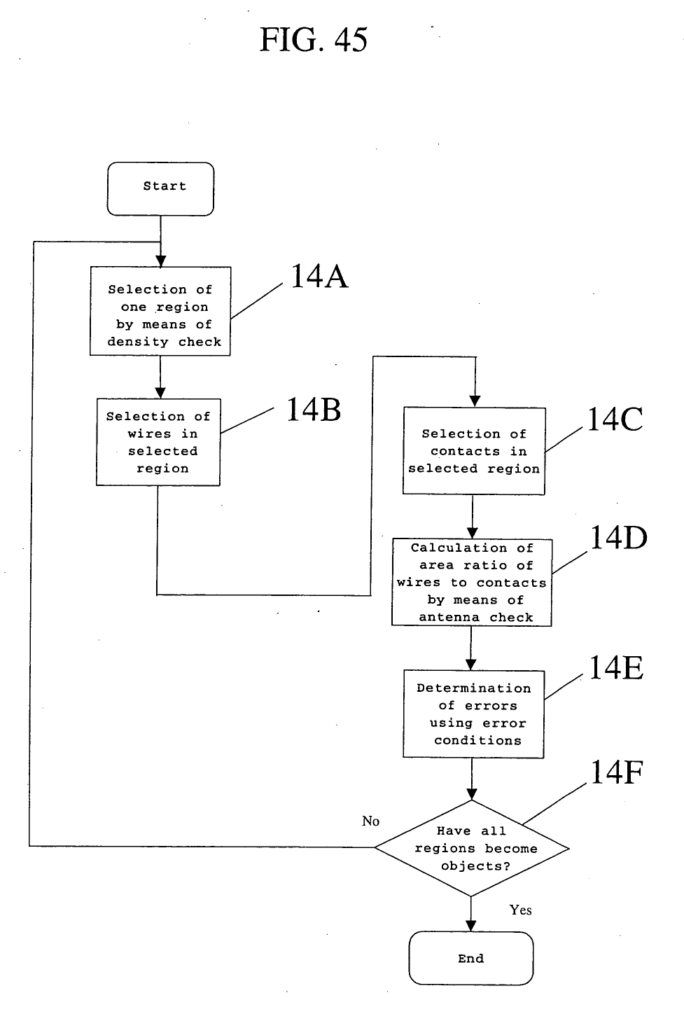

FIG. 45 is a flowchart showing an inspection algorithm according to the thirteenth embodiment of this invention. In the following, the inspection procedure is described according to the flowchart.

This semiconductor device layout inspection method is a method for inspecting the occurrence of formation defects in wires of a large area in a chip layout that includes the step of defining a partial inspection region in a chip layout; the step of limiting the area ratio of the total area of wires of the same node to the total area of the contact holes in the wires of the same node by using an antenna check in the partial inspection region; the step of detecting wire formation defects by determining whether or not defects exists based on this limitation; and the step of allowing the partial inspection region to scan the entire surface of the chip layout by using a density check.

The above described density check is the technology of inspection wherein a threshold value of a constant area ratio is determined in a single layer layout in order to increase the flatness and the etching precision in CMP (chemical mechanical polishing) at the time of manufacturing a semiconductor device.

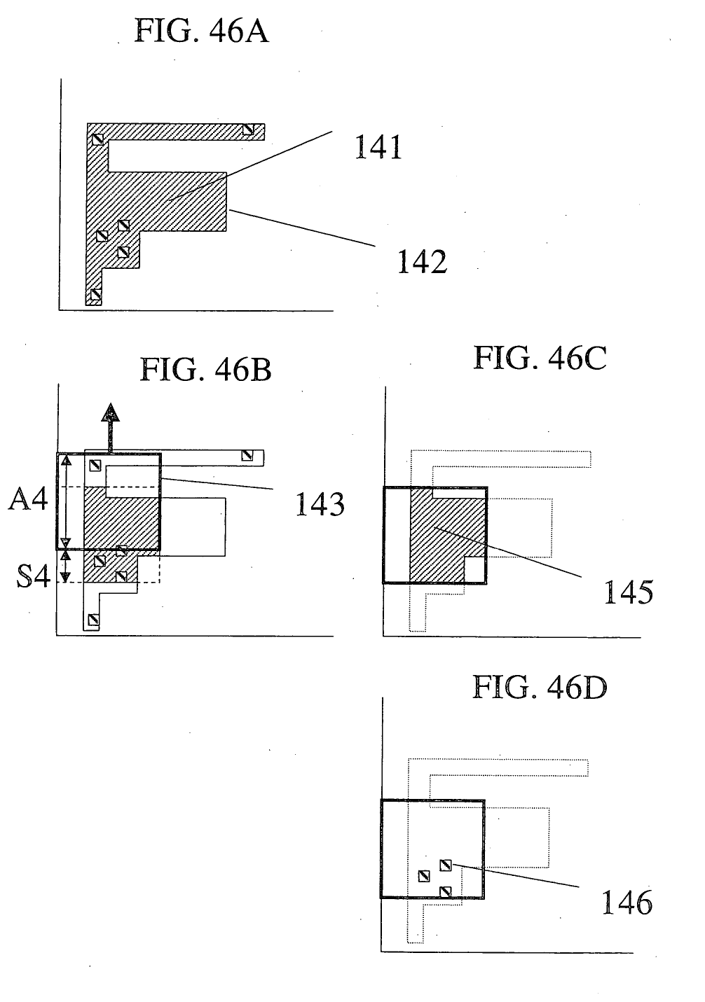

In this case, as shown in FIGS. 46A, 46B, 46C and 46D, a method is described wherein an area ratio calculation is carried out in partial inspection region 143 defined as having a size A4 in input layout 142, which is an inspection object, so that partial inspection region 143 scans the entire surface of layout 142 in shift step S4 (<A4) and, thereby, the total area ratio of the wires of the same node to the contact holes connected to the wires is limited.

An inspection is carried out in partial region 143 and the inspection is completed partial inspection region 143 shifts within the layout to be inspected so that another inspection is carried out in a different region. When partial inspection region 143 scans the entire surface the inspection of the entire surface of the layout is completed (Step 14A). A wire 145 where partial inspection region 143 and wire 141 within layout 142 overlap is selected (Step 14B) a contact hole 146 wherein partial inspection region 143 and a contact hole within layout 142 overlap is selected (Step 14C). Wire 145 and contact hole 146 selected in step 14B and step 14C are used for an antenna check so that the ratio of the total area of the wires of the same node to the total area of the contact holes in the wires of the same node is calculated (Step 14B). Though the ratio of gates and contacts connected to the gates is calculated in a conventional antenna check, it is possible to find a ratio of wires to contact holes contacted to the wires by using wire 145 instead of the gate. In the case wherein, the total area ratio calculated in step 14D is compared with predetermined error conditions so as to be found to be the limitation value or greater, the area is detected as an error portion wherein a wire formation defect will occur (Step 14E). Next, it is determined whether or not partial inspection region 143 has scanned the entire surface of the layout (Step 14F). In the case wherein the entirety has not been scanned, steps 14A to 14E are repeated. In the case wherein the entirety has been scanned, the inspection is completed.

FIG. 44 is a dataflow diagram showing a flow of data at the time of inspection according to the thirteenth embodiment of this invention. In the following, the dataflow is described.

As shown in FIG. 44, layout data 142 is inputted in partial inspection region selecting step 14a so that partial inspection region data 143 is selected and outputted. Partial inspection region data 143 and layout data 142 are inputted in wire recognition step 14b and wire data 145 that overlaps partial inspection region data 143 is selected from layout data 142. Partial region inspection data 143 and layout 142 are inputted in contact recognition step 14c and contact hole data 146 that overlaps partial inspection region data 143 is selected from layout data 142. Wire 145 selected in wire recognition step 14b and contact hole data 146 selected in contact recognition step 14c are inputted in area ratio calculation step 14d so that wire data 145 instead of the gate is used and an antenna check is carried out.

The area ratio outputted in area ratio calculating step 14d is compared with predetermined error conditions in error determination step 14e so that wire data 145 and contact hold data 146 selected are outputted as errors in the case wherein the conditions are not satisfied.

According to the above described procedure, portions where wire formation defects will occur can be detected in the input layout.

What is claimed is:

1. A semiconductor device layout inspection method for inspecting formation defects that will occur in wires of a chip layout, wherein the wire formation defects are detected by checking the relationship between the layout of the contact holes in said wires and the layout of said wires.

2. The semiconductor device layout inspection method according to claim 1, wherein the layout of wires where wire formation defects have been detected is corrected.

3. A semiconductor device layout inspection method for inspecting formation defects that will occur in wires of a chip layout, wherein the wire formation defects are detected by providing limitation to the area ratio of the total area of the wires of the same node to the total area of the contact holes in the wires of the same node of the chip layout so that existence of defects is determined based on this limitation.

4. A semiconductor device layout inspection method for inspecting formation defects that will occur in wires of a chip layout, wherein the wire formation defects are detected by providing limitation to the number of contact holes in the wires of the same node so that existence of defects is determined based on this number limitation.

5. A semiconductor device layout inspection method for inspecting formation defects that will occur in wires of a chip layout, wherein the wire formation defects are detected by providing limitation to the number of contact holes in the wires having a constant width so that existence of defects is determined based on this number limitation.

6. A semiconductor device layout inspection method for inspecting formation defects that will occur in wires of a chip layout, wherein the wire formation defects are detected by providing limitation to the total area of contact holes in the wires having a constant width so that existence of defects is determined based on this area limitation.

7. A semiconductor device layout inspection method for inspecting formation defects that will occur in wires of a chip layout, comprising: the step of calculating the total area of the wires of the same node and the total area of the contact holes in the wires of the same node; and the step of determining the area limitation value of said contact holes in accordance with said total area of the wires of the same node, wherein the area of the same node is detected as a wire formation defect when said total area of the contact holes is equal to, or is greater than, said area limitation value.

8. A semiconductor device layout inspection method for inspecting formation defects that will occur in wires of a chip layout, comprising: the step of calculating the total area of the wires of the same node and the number of the contact holes in the wires of the same node; and the step of determining the number limitation value of said contact holes in accordance with said total area of the wires of the same node, wherein the area of the same node is detected as a wire formation defect when said number of the contact holes is equal to, or is greater than, said number limitation value.

9. A semiconductor device layout inspection method for inspecting formation defects that will occur in wires of a chip layout, comprising: the step of calculating the number of the contact holes in the wires having a constant width; and the step of determining the number limitation value of said contact holes that varies in accordance with the wire width, wherein the area concerning the contact holes is detected as a wire formation defect when said number of the contact holes is equal to, or is greater than, said number limitation value.

10. A semiconductor device layout inspection method for inspecting formation defects that will occur in wires of a chip layout, comprising: the step of calculating the total area of the contact holes in the wires having a constant width; and the step of determining the area limitation value of said contact holes that varies in accordance with the wire width, wherein the area concerning the contact holes is detected as a wire formation defect when said total area of the contact holes is equal to, or is greater than, said area limitation value.

11. A semiconductor device layout inspection method for inspecting formation defects that will occur in wires of a chip layout, comprising: the step of dividing the entire area of the chip layout into a plurality of inspection regions; the step of providing limitation to the number of the contact holes in the wires of a constant width in an inspection region from among said plurality of inspection regions so that a wire formation defect is detected by determining the existence of a defect based on this number limitation; and the step of allowing said inspection region to scan the entire surface of the chip layout.

12. The semiconductor device layout inspection method according to claim 11, wherein the entire surface inspection for inspecting the entire chip surface of the chip layout and a partial inspection for inspecting a portion of the chip have different scanning intervals of the inspection regions.

13. The semiconductor device layout inspection method according to claim 11, wherein the entire surface inspection for inspecting the entire chip surface of the chip layout and a partial inspection for inspecting a portion of the chip have different sizes of the inspection regions.

14. The semiconductor device layout inspection method according to claim 5, wherein limitation is provided to the number of the contact holes in wires having a constant width after wires connected to contact holes of which the number is less than a constant number in the chip layout has been removed in advance.

15. The semiconductor device layout inspection method according to claim 5, wherein limitation is provided to the number of the contact holes in wires having a constant width in inspection regions that have been limited to the inspection regions having contact holes of which the number is equal to, or greater than, a constant number from among the plurality of inspection regions.

16. A semiconductor device layout inspection method for inspecting formation defects that will occur in wires of a chip layout, comprising: the step of dividing the entire area of the chip layout into a plurality of inspection regions; and the step of providing limitation to the area ratio of the total area of the wires of the same node to the total area of the contact holes in the wires of the same node using an antenna check in an inspection region from among said plurality of inspection regions so that a wire formation defect is detected by determining the existence of a defect based on this limitation; and the step of allowing said inspection region to scan the entire surface of the chip layout.

17. A semiconductor device layout inspection method for inspecting formation defects that will occur in wires of a chip layout, comprising: the step of defining a partial inspection region in the chip layout; the step of providing limitation to the area ratio of the total area of the wires of the same node to the total area of the contact holes in the wires of the same node using an antenna check in said partial inspection region so that a wire formation defect is detected by determining the existence of a defect based on this limitation; and the step of allowing said partial inspection region to scan the entire surface of the chip layout using a density check.
